(19) United States
(12) Patent Application Publication
(10) Pub. No.: US 2025/0237896 A1
(43) Pub. Date: Jul. 24, 2025

(54) MULTILAYERED SIGNAL GUIDING STRUCTURE AND METHOD OF OPERATING A MULTILAYERED SIGNAL GUIDING STRUCTURE

(71) Applicant: Fraunhofer-Gesellschaft zur Förderung der angewandten Forschung e.V., München (DE)

(72) Inventors: Sevag ABADIAN, Berlin (DE); Tolga TEKIN, Berlin (DE); Marian Bogdan Sirbu, Berlin (DE); Michail Symeonidis, Berlin (DE)

(21) Appl. No.: 19/024,668

(22) Filed: Jan. 16, 2025

(30) Foreign Application Priority Data
Jan. 24, 2024 (DE) 102024200644.0

(51) Int. Cl. G02F 1/095

(52) U.S. Cl. CPC G02F 1/0955

(57) ABSTRACT

Described is a multilayered signal guiding structure, comprising: a plurality of layers, the plurality of layers comprising at least two waveguide layers extending along an extension direction and serving to couple an electromagnetic signal, and at least one intermediate layer disposed between the at least two waveguide layers; at least two cover layers, wherein the at least two waveguide layers are partially or completely arranged between the at least two cover layers, wherein the at least one intermediate layer comprises a magneto-optical material, MO, and/or the at least two cover layers comprise a magneto-optical material, MO. Furthermore, a method for operating a multilayered signal guiding structure is described.

### CROSS-REFERENCE TO RELATED APPLICATIONS

This application claims priority from German Patent Application No. 102024200644.0, which was filed on Jan. 24, 2024, and is incorporated herein in its entirety by reference.

The present invention describes a multilayered signal guiding structure and a method for operating a multilayered signal guiding structure. A principle of efficient signal routing is described, which is used in particular in switches, circulators and isolators.

### BACKGROUND OF THE INVENTION

Data centers represent critical components in the contemporary digital landscape, serving as centralized hubs for data processing, storage, and distribution. The proliferation of mobile applications, alongside the growing complexity of these applications, has led to a substantial escalation in data traffic. This surge can be attributed to factors such as increased user engagement with smartphones, augmented reality applications, high-definition video streaming, and the Internet of Things. Consequently, data centers face the formidable challenge of accommodating the escalating data throughput requirements, necessitating continuous advancements in hardware and software infrastructure. The optimization of data center design, including the adoption of high-performance computing, energy-efficient cooling solutions, and advanced networking protocols, has become imperative to ensure the uninterrupted flow of data, minimize latency, and address the ecological implications of heightened energy consumption.

Photonics is a promising tool in addressing the mounting data traffic challenges within data centers. Photonics integrated circuits (PICs), offer the potential reductions in both power consumption and footprint. Over the past decades, continuous effort has been implemented to develop photonic components having different functionalities. To direct data traffic, efficient and chip integratable switches and circulators are of high demand. Moreover, PICs that need integrated or external lasers necessitate the use of optical isolators in order to block off any signal travelling towards the source, which could deteriorate performance. To this day, the proposed bulky configurations remain demanding with many technological steps for on chip integration. On the other hand, waveguiding solutions suffer from high insertion losses (I.L) and exhibit unsatisfactory isolation ratio (I.R).

Over the past decades, the growth of digital communication and information exchange has been exponential. There is an increasing need for the development of circuits that offer improved functionality. Advancement of components such as switches, circulators and isolators, which play a pivotal role in enabling efficient and seamless data flow across diverse applications, is essential.

To achieve these functionalities, a medium that breaks spatial and time symmetry is needed [1].

Over the past decades, these components have been demonstrated both experimentally and theoretically. Various mechanisms with different architectures have been proposed and thoroughly explored based on MO, electro-optics (EO), acousto-optics (AO), optomechanical (OM), photonic transition (PT), Photonic crystal (PhC), piezoelectric (PZT) interactions.

For switches, microring resonator (MRR) and Mach-Zehnder interferometer (MZI) configurations have been studied and evaluated. In the MRR case, a microring is there to provide resonance at a specific wavelength (λ₀). Upon the exertion of external magnetic field in clockwise (CW) and counterclockwise (CCW) directions, the resonance is red or blue shifted. Utilizing such a device, with a wavelength shift of 0.14 nm, an extinction ratio of 21 dB was obtained at a λ₀=1.561 μm [2].

MZI-based MO-al switches were also explored. Usually comprising of a combination of an unbalanced MZI, MMI couplers, an asymmetric phase bias and a MO-al phase shifter. At λ₀=1.541 μm and for a device length of 1.2 mm and current ±400 mA, an extinction ratio of 25 dB was observed with I.L=10 dB [2].

Another approach was demonstrated in [3]. The design includes two tapered multimode sections where TE₀ and TE₁ modes are excited equally, the TE₁ mode is then converted into TM. In the central waveguide of the MO phase shifter, the TM mode experiences a phase shift. The phase difference between the TE and TM modes determines the interference between the TE₀ and TE₁ modes of the output half-mode converter. When the TM mode experiences phase shift of ±π/2, the output port of the light signal is selected by changing the magnetization. For a device L=950 μm, I.L=6.7 dB and an I.R=19.9 dB was obtained at λ₀=1.5753 μm.

For MO circulators, in [4], three waveguides were coupled with a metallic nanorod heterostructure, placed in a uniformly magnetized MO material. At λ₀=1.43 μm, the system exhibits a sharp plasmonic resonance, and the structure redistributes the input power between the junction arms with up-to 63% of power transmitted through one of the output ports, with almost complete isolation for the other output port.

Magneto-PhCs were also exploited theoretically to demonstrate circulators. Working in a uniform external magnetic field, researchers showed a significant splitting of the eigenfrequencies of the two counterrotating modes. Using three PhC waveguides coupled to a MO cavity, a 20 dB isolation ratio (I.R) was computed at a λ₀=1.3 μm [5]. Similarly, in [6] I.R=30 dB was found for λ₀=0.633 μm and λ₀=1.55 μm.

For isolators, one of the first attempts was to reproduce the principle of the bulk Faraday isolators. Low forward and high backward I.L are the characteristics of this bulky isolator that is incompatible with PICs. This isolator needs the integration of polarizers into the system that has yet to be accomplished. From here, there is a push towards achieving isolators in waveguiding configuration [7].

Among the different MO effects, the TMOKE (Transverse Magneto-Optical Kerr Effect) appears as the most compatible solution due to its advantage of not effecting the polarization of the input light.

In the NRL (Non-Reciprocal Losses), the combination of a semiconductor optical amplifier (SOA) with a ferromagnetic coating is investigated. By injecting a current into the SOAs the losses in the forward direction can be compensated. The polarization-dependent design configures the imaginary component of the effective refractive index, resulting in unequal losses in the opposite propagation directions. In TM configuration [8], at λ₀=1.3 μm, the design was validated and demonstrated approximately I.R=99 dB/cm. In TE configuration [9], at a λ₀=1.55 μm, the design was validated and demonstrated I.R=14.7 dB/mm.

In the NRPS (Non-Reciprocal Phase Shift) effect, a change in the real part of the effective refractive index is observed, which results in a phase difference between the forward and backward signals. Here, an MZI is covered with a magnetic rare garnet. In this passive design, light would constructively interfere in the forward sense and destructively in the backward sense. Many research groups exploited the NRPS; an I.R=19 dB was achieved at λ₀=1.54 μm with a L=8 mm [10].

In resonator devices, many groups developed highly resonant microrings. Approaches varied with respect to the geometry (radius) and placement (filling material: in the disk, cladding material: applied on top of the resonator). Regarding the first scenario, I.R=20 dB was recorded, along with I.L lower than 0.1 dB and a bandwidth of 0.4 nm [11]. As for the cladding solution, a first demonstrator exhibited I.R=19.5 dB for L=290 μm [12], while a second achieved 9 dB I.R at λ₀=1.55 μm [13].

Magnetoplasmonic isolators based on the TMOKE effect were also investigated. In this case, garnets and metals were integrated to leverage the SPP confinement along the metal/dielectric interface. In the design of magnetoplasmonic MZIs, researchers achieved an I.R=22.82 dB with low I.L [14]. Others utilized a magnetoplasmonic slot guide to excite an LRSPP mode using a taper. This resulted in an I.R=30 dB, λ₀=1.55 μm [15], although promising results were shown, however for a complete device with input/output couplers, the isolator would have I.L>10 dB.

We summarize in table 1 MO and non-MO isolator principles and performances published since 1988.

TABLE 1
Summary of different types of optical isolators, MO (dark gray) and
non-MO (light gray) types, their operational polarization, guiding material,
functioning wavelength λ₀ and characteristics I.R, I.L, L.

| | | | | Guiding | | λ₀ | I.R | I.L | L |
|---|---|---|---|---|---|---|---|---|---|
| Year | Ref. | Authors | Mode | material | Type | (μm) | (dB) | (dB) | (mm) |
| 1988 | [16] | Ando | TE- | Garnet | FR | 1.15 | 12.5 | 8.8 | 7 |
| | | | TM | | | | | | |
| 1989 | [17] | Castera | TE- | Garnet | FR | 1.55 | 23 | 10 | — |
| | | | TM | | | | | | |
| 1996 | [18] | Levy | TE- | Garnet | FR | 1.52 | 29 | 7 | 3.5 |
| | | | TM | | | | | | |
| 1996 | [19] | Sugimoto | TE- | Garnet | FR | 1.55 | 25 | 3.2 | 3.02 |
| | | | TM | | | | | | |
| 1998 | [20] | Shintaku | TE- | Garnet | FR | 1535 | 27 | 5 | 4.1 |
| | | | TM | | | | | | |
| 2000 | [21] | Fujita | TM | Garnet | NRPS | 1.54 | 19 | 13.6 | 8 |
| 2000 | [22] | Yokoi | TM | SOA & | NRPS | 1.55 | 4.9 | — | — |
| | | | | ferromagnet | | | | | |
| 2006 | [23] | Van | TM | SOA & | NRL | 1.29 | 3.77 | 18 | 0.38 |
| | | Parys | | ferromagnet | | | | | |
| 2006 | [24] | Shimizu | TE | SOA & | NRL | 1.55 | 14.7 | 7.1 | 1 |
| | | | | ferromagnet | | | | | |
| 2007 | [25] | Kono | TM | Si & garnet | NMRR | 1.3 | 20 | 0.1 | 0.04 |
| 2008 | [26] | Shoji | TM | Garnet | NRPS | 1548 | 30 | 13 | 1.5 |
| 2009 | [27] | Montoya | TM | SOA & | NRC | 1.55 | 30 | 3 | 0.05 |
| | | | | garnet | | | | | |
| 2011 | [28] | Zhu | TM | Garnet | NMRR | 0633 | 20 | — | 0003 |
| 2011 | [29] | Bi | TM | Si & garnet | NRPS | 1542 | 19.5 | 18.8 | 0.29 |
| 2019 | [30] | Zhang | TE | Si & garnet | NRPS | 1574 | 30 | 6 | 0968 |
| 2019 | [31] | Srinivasan | TE- | Si & garnet | NRMC | 1.55 | 11 | 6 | 6 |
| | | | TM | | | | | | |
| 2021 | [32] | Abadian | TM | Au & Garnet | MBPE | 1.55 | 30 | 10 | 0.01 |
| 2010 | [33] | Z. Yu | TE | Si | PT | 1.55 | 30 | 3.5 | 2.19 |
| 2012 | [34] | Wang | — | SOI | PhC | 1582 | 13.5 | 6.47 | 0006 |
| 2016 | [35] | Ruesink | TE/TM | SiO₂ | OM | 1.55 | 10 | 15 | 0041 |
| 2020 | [36] | Kittlaus | TE | AIN & SOI | AO | 1.5237 | 16 | 0.6 | 15.3 |
| 2021 | [37] | Tian | TE/TM | AIN & SIN | PZT | 1.5426 | 9.3 | 0.8 | — |
| 202 | [38] | Goswami | TM | Si | PhC | 1.55 | 30 | 1 | 0.2 |
| 2023 | [39] | M. Yu | TE | LN | EO | 1554 | 48 | 1.5 | 20 |

FR-based designs are bulky and not suitable for on chip integration. NRL and NRPS one's need additional SOA-s with complex technological processes, and possess high I.L. Resonator structures provide large I.R however they are strictly limited due to a short bandwidth. Magnetoplasmonic designs offer satisfactory performance, however absorption due to the metal can severely affect the intensity of the output signal. Non-MO based devices suffer from large footprint and moderate I.R.

### SUMMARY

According to an embodiment, a multilayered signal guiding structure may have: a plurality of layers, wherein the plurality of layers includes at least two waveguide layers, which extend along an extension direction and which serve to couple an electromagnetic signal, and at least one intermediate layer that is arranged between the at least two waveguide layers; at least two cover layers, wherein the at least two waveguide layers are partially or completely arranged between the at least two cover layers, wherein the at least one intermediate layer includes a magneto-optical material, MO, and/or the at least two cover layers include a magneto-optical material, MO.

According to another embodiment, a method for operating a multilayered signal guiding structure, in particular the inventive one, may have the steps of: providing a multilayered signal structure, having: a plurality of layers, wherein the plurality of layers includes at least two waveguide layers which extend along an extension direction and which serve to couple an electromagnetic signal, and at least one intermediate layer which is arranged between the at least two waveguide layers; at least two cover layers, wherein the at least two waveguide layers are partially arranged between the at least two cover layers, wherein the at least one intermediate layer includes a magneto-optical material, MO, and/or the at least two cover layers include a magneto-optical material, MO; and applying an external magnetic field to the multilayered signal guiding structure, whereby a transverse-magnetic mode, TM mode, or a transverse-electric mode, TE mode, of an electromagnetic signal introduced into the multilayered signal guiding structure undergoes a change in its electromagnetic field profile aligned along an extension direction of the at least two waveguide layers.

According to a proposal, the multilayered signal guiding structure comprises a plurality of layers, the plurality of layers comprising at least two, in particular dielectric, waveguide layers, which extend along an extension direction and which serve to couple in an electromagnetic signal, and at least one, in particular dielectric, intermediate layer that is arranged between the at least two waveguide layers. The multilayered signal guiding structure further comprises at least two, in particular dielectric, cover layers, wherein the at least two waveguide layers are partially or completely arranged between the at least two cover layers. According to the proposal, the at least one intermediate layer comprises a magneto-optical material, MO, and/or the at least two cover layers (30) comprise a magneto-optical material, MO. The at least two waveguide layers are positioned parallel to each other in the multilayered signal guiding structure. In particular, an air layer may also serve as a cover layer or various materials as described herein may be used. The at least one intermediate layer may be configured as an air layer or different materials as described herein may be used. In particular, several multilayered signal guiding structures may be used on top of each other, i.e. stacked (horizontally or vertically, i.e. along the y-direction and/or along the z-direction), in order to efficiently define a signal guide. For example, at least two multilayered signal guiding structures may be stacked to obtain coupled TM/TE modes perpendicular to or in the extension direction. By way of example, the multilayered signal guiding structure is described on the basis of five layers in order to simplify the understanding of the derivation of the principles of the proposed technical teaching for the reader of the present application. However, the proposed multilayered signal guiding structure may have more than five layers. In particular, an external magnetic field may be applied to the multi-layered signal guiding structure, whereby electromagnetic signals, i.e. electromagnetic waves, can be selectively guided in a predetermined direction or in several predetermined directions when using the multi-layer signal guiding structure, during which a flow of electromagnetic signals in a different direction can be specifically suppressed or reduced. When the multilayered signal guiding structure is used in an external magnetic field, signals in the multilayered signal guiding structure can be efficiently guided in one or more predetermined directions, substantially without large i.L.

According to a further aspect, a method for operating a multilayered signal guiding structure is described. In the proposed method, a multilayered signal guiding structure as described herein is used. The method comprises providing a multilayered signal structure comprising a plurality of layers, the plurality of layers comprising at least two waveguide layers extending along an extension direction and serving to couple an electromagnetic signal, and at least one intermediate layer disposed between the at least two waveguide layers. Furthermore, the multilayered signal guiding structure comprises at least two cover layers, wherein the at least two waveguide layers are partially arranged between the at least two cover layers, wherein the at least one intermediate layer comprises a magneto-optical material, MO, and/or the at least two cover layers comprise a magneto-optical material, MO. The method further comprises applying an external magnetic field to the multilayered signal guiding structure, whereby a transverse magnetic mode, TM/TE mode, of an electromagnetic signal introduced into the multilayered signal guiding structure undergoes a change in its electromagnetic field profile aligned along an extension direction of the at least two waveguide layers.

The disclosure concerning the multilayered signal guiding structure also applies to the disclosed method, although the details are not repeated for reasons of redundancy. Rather, reference is made to the description of the multilayered signal guiding structure.

The proposed invention describes a novel method and a novel multilayered signal guiding structure for signal routing that could be implemented to achieve efficient photonic switches, circulators and isolators with negligible I.L. and low power consumption. The developed components are simple and straightforward, all designs are based on a multilayered, in the figures especially five-layered, magneto-optical (MO) heterostructure or also called signal guiding structure, in which coupled optical modes, especially in parallel dielectric waveguides, exchange power in the presence of an MO material that is externally magnetized.

The proposed invention pertains to three optical components: switches, circulators and isolators, completely in dielectric format and based on MO-s to make PIC integration possible.

The proposed invention does not require complex technological steps to manufacture and has the advantage of easy integration into PICs. In addition, 100% performance can be achieved for each MO material (each gyrotropy level) by modifying the geometric dimensions of the heterostructure, also known as the signal guiding structure. Unlike other designs, this does not affect the performance of the component, as the input signal here propagates in the waveguides, especially dielectric ones, without much interaction with the MO material itself, making the design tolerable in terms of I.L., which can be estimated to be less than a few db/cm. Finally, when used, these components need an external magnetic field applied to the signal line structure, which is applied to the signal line structure in the TMOKE configuration. The external magnetic field may be provided by a rare earth magnet or an electromagnet.

### BRIEF DESCRIPTION OF THE DRAWINGS

Embodiments of the present invention will be detailed subsequently referring to the appended drawings, in which:

FIG. 1 shows a top view of a first configuration of the multilayered signal guiding structure, with the MO material arranged between the at least two, in particular parallel, waveguide layers;

FIG. 2 shows a top view of a second configuration of the multilayered signal guiding structure, with the MO material arranged on two of the at least two, in particular parallel, waveguide layers;

FIG. 3a, b show a top view of a third configuration of the multilayered signal guiding structure, wherein the MO material is arranged on two of the at least two, in particular parallel, waveguide layers and wherein the MO material is arranged between the at least two, in particular parallel, waveguide layers (see FIGS. 3a and 3b);

FIG. 4 shows a top view of a first partition of the multilayered signal guiding structure with only one waveguide layer, i.e. waveguide a.

FIG. 5 shows a top view of a further partition of the multilayered signal guiding structure with only one waveguide layer, i.e. waveguide b.

FIG. 6 shows a ratio, which was calculated for different gyrotropy values (g=0.1; 0.05; 0.01) and as a function of the varying width of the at least one intermediate layer (gap width);

FIG. 7 shows coupling length plots, calculated for different gyrotropy values g (g=0.1; 0.05; 0.01) as a function of the varying width of the at least one intermediate layer (gap width);

FIG. 8 shows a ratio, which was calculated for different gyrotropy values (g=0.01; 0.005; 0.001) and as a function of the varying width of the at least one intermediate layer (gap width);

FIG. 9 shows coupling length plots, calculated for different gyrotropy values g (g=0.01; 0.005; 0.001) as a function of the varying width of the at least one intermediate layer (gap width);

FIG. 10 shows power P in the at least two waveguide layers (waveguide a (black) and b (gray)) of the multilayered signal guiding structure as a function of the coupling length Lc, which is used, for example, in a switch or a circulator;

FIG. 11 shows power P in the at least two waveguide layers (waveguide a (black) and b (gray)) of the multilayered signal guiding structure in the forward direction as a function of the double coupling length 2Lc, which is used, for example, in an isolator;

FIG. 12 shows power P in the at least two waveguide layers (waveguide a (black) and b (gray)) of the multilayered signal guiding structure in the backward direction as a function of the double coupling length 2Lc, which is used, for example, in an isolator;

FIG. 13 shows a flowchart of a method for operating the multilayered signal guiding structure;

FIG. 14 shows a top view of a dielectric MO switch with an external magnetic field directed inwards, with light entering through a first input port I₁ and light exiting through a second output port O₁;

FIG. 15 shows a top view of a dielectric MO switch with an external magnetic field directed outwards, with light entering through a first input port I₁ and light leaving through a second output port O₂;

FIG. 16 shows a top view of a dielectric MO circulator with light entering through a first input port I₁ and light leaving through a second output port O₂;

FIG. 17 shows a top view of a dielectric MO circulator with light entering through a second input port I₂ and light leaving through a third output port O₃;

FIG. 18 shows a top view of a dielectric MO circulator with light entering through a third input port I₃ and light exiting through a first output port O₁;

FIG. 19 shows a top view of a dielectric MO isolator with light traveling in the forward propagation sense; and

FIG. 20 shows a top view of a dielectric MO isolator with light traveling in the backward propagation sense.

### DETAILED DESCRIPTION OF THE INVENTION

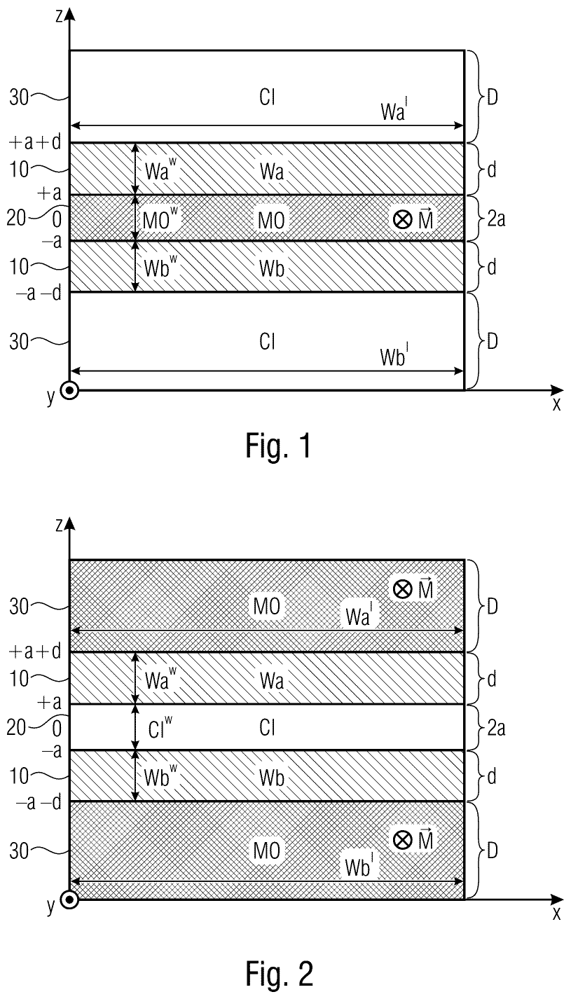

Individual aspects of the invention described herein are described below in FIGS. 1 to 20. In the present application, identical reference signs refer to identical or similarly acting elements, wherein not all reference signs need to be set out again in all drawings if they are repeated.

When a component is described as “configured to do something” herein, it is intended to mean that the component has been structurally and physically designed to do what it is designed to do.

In the present case, the term “signal” refers to an electromagnetic wave. The terms “signal” and “electromagnetic wave” are used synonymously. The terms “waveguide layer” and “waveguide” are also used synonymously.

The proposed multilayered signal guiding structure 100 comprises a plurality n of layers, the plurality n of layers comprising at least two waveguide layers 10, in particular a first waveguide layer a and a second waveguide layer b, which extend along an extension direction x and which serve to couple an electromagnetic signal, and at least one intermediate layer 20, which is arranged between the at least two waveguide layers 10. The multilayered signal guiding structure 100 further comprises at least two cover layers 30, wherein the at least two waveguide layers 10 are partially or completely arranged between the at least two cover layers 30. According to the proposal, the at least one intermediate layer 20 comprises a magneto-optical material, MO, and/or the at least two cover layers 30 comprise a magneto-optical material, MO. These three possible configurations of the multilayered signal guiding structure 100 are shown schematically in FIGS. 1 to 3. The MO material may also be a ferromagnetic metal, a semi-metal or a semiconductor, for example. The at least two waveguide layers 10 may be, for example: a dielectric such as silicon Si, silicon nitride SiN, polymer or epoxy or a hybrid consisting of a dielectric and a metal.

The at least one intermediate layer 20 may consist of ferromagnetic metals such as copper CU or iron FE, silicon dioxide or polymers doped with iron nanoparticles, or garnets such as YIG, BIG, TIG, GGG, which may be further doped to enhance their MO effects. However, dielectric materials are advantageous for layers 10, 20, 30. The at least two cover layers may be provided by SiO2 or air, for example, but not by a metal.

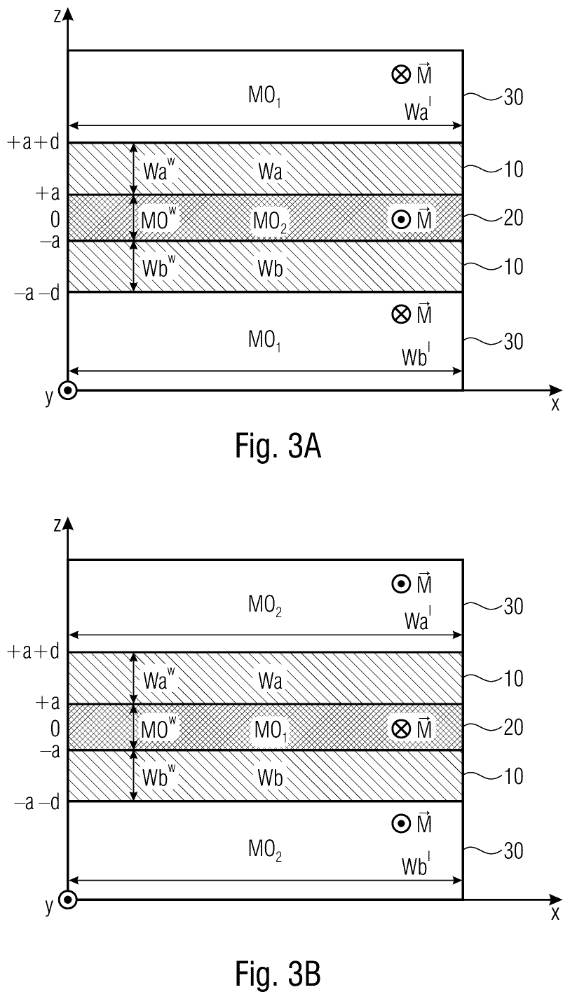

FIG. 1 shows a top view of a first configuration of the multilayered signal guiding structure 100, wherein the MO material is arranged between the at least two, in particular parallel, waveguide layers 10. According to the first configuration, the at least one intermediate layer 20 comprises the MO material. FIG. 2 shows a top view of a second configuration of the multilayered signal guiding structure, with the MO material arranged on two of the at least two, in particular parallel, waveguide layers. According to the second configuration, the at least two cover layers 30 comprise the MO material. FIGS. 3a and 3b show a top view of a third configuration of the multilayered signal guiding structure, wherein the MO material is arranged on two of the at least two, in particular parallel, waveguide layers and wherein the MO material is arranged between the at least two, in particular parallel, waveguide layers.

According to the third configuration, the at least one intermediate layer 20 comprises a second MO material and the at least two cover layers 30 comprise a first MO material. The first and second MO materials can be different from each other. In particular, the first and second MO materials have different gyrotropy values g. In particular, the external magnetic fields exerted on the first and second MO material are directed in opposite directions. For this purpose, two oppositely aligned magnetic fields are applied to the two identical or different MO materials by locally depositing permanent magnets on the MO materials.

In FIGS. 1 to 3a, 3b is each drawn in a coordinate system (x,y,z). As may also be seen in FIGS. 1 to 3a, 3b, the direction of extension extends along the x-axis. The various layers 10, 20, 30 have a length along the direction of extension along the x-axis. The layers 10, 20 and 30 each have a thickness along the z-axis. A single waveguide layer 10, a, b has a thickness d. A single intermediate layer 20 in FIGS. 1 to 3a, 3b has a thickness 2a. A single cover layer 1 to 3a, 3b has a thickness D.

The layers 10, 20, 30 are arranged directly on top of each other, as shown in FIGS. 1 to 3, 3b.

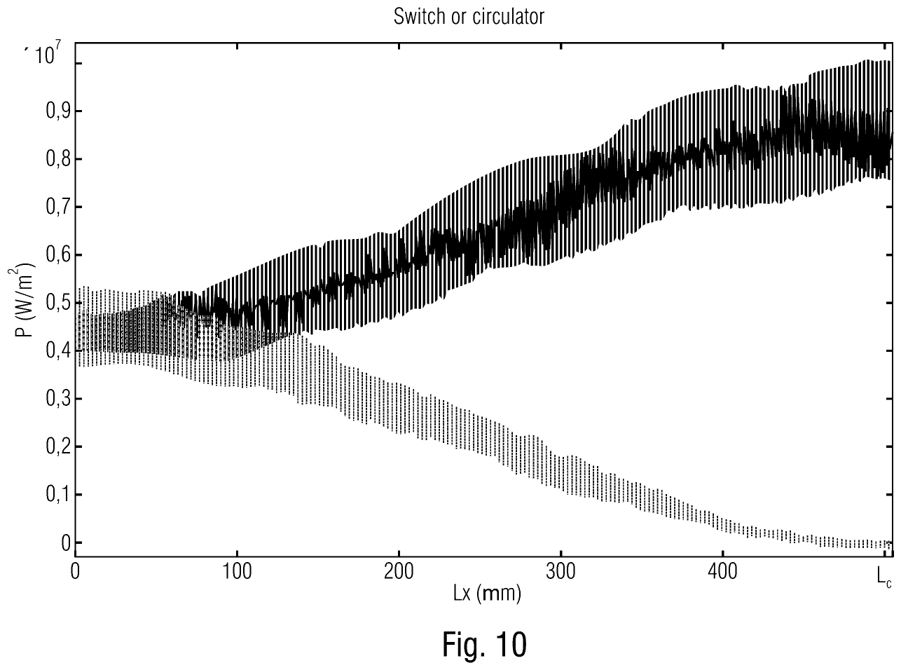

An external magnetic field can be applied or is applied to the multilayered signal guiding structure 100, whereby an optical mode, for example a transverse-magnetic mode, TM mode, and/or a transverse-electric mode, TE mode, of the electromagnetic signal coupled into the at least two waveguide layers 10 undergoes a change in its magnetic field profile aligned along the direction of extension of the at least two waveguide layers 10. The change in the magnetic field profile (i.e. a resulting magnetization) has an effect on a measured power P, as shown for example in FIGS. 10, 11 and 12, which will be described in detail below. In FIGS. 1 to 3a, 3b, for example, the orientation of the magnetic field can be seen schematically. FIG. 1 shows that the magnetization is directed inwards.

It should be noted that with the present invention at least one transverse-magnetic mode, TM mode, and/or at least one transverse-electric mode, TE mode, can be generated in the multilayered signal guiding structure 100, in particular which propagate in the direction of extension of the at least two waveguide layers.

In FIG. 1, the at least one intermediate layer 20 comprises the MO material, as a result of which the external magnetic field is directed inwards (see x in the circle in layer 20 in FIG. 1).

In FIG. 2, the at least two cover layers 30 comprise the MO material, which means that magnetization is also directed inwards in this case.

In FIGS. 3a and 3b, the layers 20 (at least one intermediate layer) and 30 (the at least two cover layers) comprise the MO material; in particular the layers 20 and 30 consist of the MO material. The applied external magnetization is directed in opposite directions (inwards and outwards or outwards and inwards). Depending on the orientation of the externally applied magnetic field, the magnetization in the MO material is oriented outwards (layers 30) and inwards (layer 20) (FIG. 3a) or inwards (in layers 30) and outwards (in layer 20) (FIG. 3b). According to FIG. 3b, the magnetization of the at least two cover layers is directed inwards. The magnetization of the at least one intermediate layer 20 is directed outwards. The magnetization runs in opposite directions in layers 20 and 30. Accordingly, according to FIG. 3a, the magnetization of the at least two cover layers 30 is directed outwards. The magnetization of the at least one intermediate layer 20 is directed inwards. The magnetization in layers 20 and 30 also runs in opposite directions in FIG. 3a. In other words, the local external magnetic field acting on the MO material in the center is opposite to that acting on the MO outside the waveguide. The magnetization therefore runs in opposite directions in layers 20 and 30.

Opposing magnetic fields in at least two MO layers can be generated by depositing magnets on the different MO layers and controlling the magnets independently of each other. Permanent magnets or non-permanent magnets may be arranged on the MO layers.

In magneto-optical materials, the direction of magnetization is influenced by an externally applied magnetic field. The term “magnetization direction” usually refers to the orientation of the magnetic moments within the MO material. Without an external magnetic field, the magnetic moments may be randomly aligned or follow the crystallographic axes of the material.

If an external magnetic field is applied to the MO material or materials, the external magnetic field can induce (align) an advantageous orientation of the magnetic moments. The orientation of the magnetic moments influences the optical properties of the MO material or materials, such as the ability of the MO material to rotate the plane of polarization of light, which is the basis for magneto-optical effects. In summary, it can be said that the magnetization of the material and the applied external magnetic field go hand in hand; the magnetization of the layer does not exist without the externally applied magnetic field.

In physics, the representation of vectors, e.g. in a magnetic field, is often used to show their orientation in relation to the image plane. If a vector is represented as a circle with a point, this means that it points to the image plane. If the vector is displayed as a circle with a cross, it points out of the image plane.

The at least two waveguide layers 10 and/or at least one intermediate layer 20 and/or the at least two cover layers 30 are dielectric. In this case, the multilayered signal guiding structure is a multilayered dielectric signal guiding structure. The multilayered signal guiding structure already described could comprise at least one dielectric layer 10, 20, 30. It is also conceivable that each of the layers 10, 20, 30 has a dielectric configuration.

The external magnetic field may be provided by a rare-earth magnet or an electromagnet, which is configured to saturate the MO material. The electromagnet is advantageous. The electromagnet may comprise a thin metal layer or a semi-metal layer or a semiconductor layer, which is arranged directly on the MO material or on one of the at least two cover layers 30. With reference to FIG. 1, the electromagnet (not shown in FIG. 1) could be arranged on the MO material of the at least one intermediate layer 20 or on the at least two cover layers 30.

A wave propagation of the electromagnetic signal coupled into the at least two waveguide layers 10 is described in each case, in particular individually, by a propagation constant βₐ, β_{b}, wherein the propagation constants βₐ, β_{b} of the at least two waveguide layers 10 are different, βₐ≠β_{b}. The fact that the propagation constants βₐ, β_{b} are different is due to the presence of the MO layer, which leads to a break in spatial symmetry. Whenever at least one MO material is present in one of the three configurations, the propagation constants βₐ, β_{b} in the individual waveguide layers 10, a, b differ from each other.

When an external magnetic field is applied, at least one, in particular optical, TM mode or TE mode propagates in at least one waveguide layer 10, a, b, of the at least two waveguide layers 10, a, b along the direction of extension, at least one, in particular, even TM mode (TE mode) being described by a first propagation constant βₑ and one, in particular optical, odd TM mode (TE mode) is described by a second propagation constant βₒ, wherein the at least two waveguide layers 10, a, b are each described by the further propagation constants βₐ, β_{b}, which have already been described, wherein at a ratio of the propagation constants of

$$Ratio = \frac{{β}_{a} - {β}_{b}}{{β}_{e} - {β}_{o}} = 0.707107 == \frac{1}{\sqrt{2}}$$

a maximum power transmission takes place, wherein βₐ is the propagation constant of the, in particular optical, TM mode of the first waveguide layer 10, a of the at least two waveguide layers 10 and β_{b} is the propagation constant of the, in particular optical, TM mode of the second waveguide layer 10, b of the at least two waveguide layers 10. The statements on TM mode also apply to an electrical mode, TE mode.

Each waveguide layer 10, a, b defines a coupling length due to its nature, so that the coupled modes introduced into the waveguide layer 10, a, b are decoupled after covering the coupling length L_{C}. Furthermore, these modes should propagate over a distance called “coupling length” in order to decouple, so that in the end only one mode of them remains, whose power is concentrated exclusively in one of the waveguides a, b, especially parallel ones. The coupling length L_{C} is a function of the first and second propagation constants βₑ, βₒ of the even and odd modes and is given by:

$${L}_{c} = \frac{π}{{β}_{e} - {β}_{0}}$$

Each MO material used in the multilayered signal structure 100 has a gyrotropy level or different gyrotropy levels. According to the first configuration, in which the multilayered signal guiding structure 100 comprises a MO material in the at least one intermediate layer 20, the MO material has a single gyrotropy level. According to the second configuration, in which the multilayered signal guiding structure 100 comprises a MO material in each of the at least two cover layers 30, two different gyrotropy levels may be present. However, the external magnetization should be oriented in the same direction. According to the third configuration, in which the at least one intermediate layer 20 and the at least two cover layers 30 each comprise a MO material, up to three different gyrotropy levels may be present.

However, the external magnetic field in the at least one intermediate layer should be opposite to the external magnetic field in the at least two cover layers 30. The at least two cover layers 30 each have the same gyrotropy level, which may, however, differ from the gyrotropy level in the at least one intermediate layer 20. However, it is also conceivable that all three gyrotropy levels are the same.

One, in particular geometric, length L of the at least two waveguide layers 10 and one, in particular geometric, length L′ of the at least one intermediate layer 20 are of equal length. In particular, the geometric length L corresponds to a multiple of the coupling length L_{C}. The coupling length L_{C}, for example, depends on many different factors, such as the wavelength of the electromagnetic signal and/or a length-thickness index of the waveguide layer 10 and/or the MO material or MO materials used. The length-thickness index of the waveguide layer 10 refers to the geometric length L and the geometric thickness of the waveguide layer 10. In the case of an isolator, for example, the geometric length L corresponds to twice the coupling length L_{C}. This is because the light entering the waveguide layers 10 has to decouple and then recouple. In the case of a switch, for example, the geometric length L corresponds to the single coupling length L_{C}. This is because the light entering the waveguide layers 10 only has to decouple.

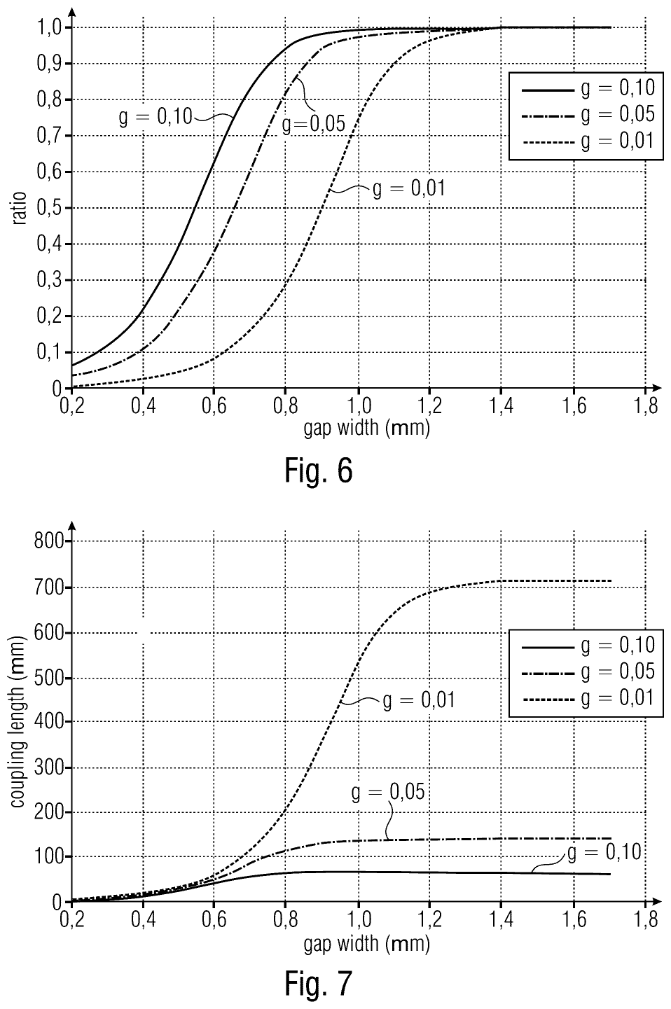

FIG. 6 shows a

$$ratio = \frac{{β}_{a} - {β}_{b}}{{β}_{e} - {β}_{o}}$$

of the two propagation constants βₐ, β_{b} and the even and odd modes βₑ, βₒ. The

$$ratio = \frac{{β}_{a} - {β}_{b}}{{β}_{e} - {β}_{o}}$$

was calculated for a constant thickness d (d indicates the width along the z-direction of a waveguide a, b) of the at least two waveguide layers 10 as a function of the at least one intermediate layer 20 (2a, gap width) for different gyrotropy values g. This ratio is shown in FIG. 6 in relation to the width 2a of the at least one intermediate layer 20 (gap width) for different gyrotropy values g. FIG. 7 shows a representation of the coupling length, calculated for different gyrotropy values g as a function of the variation in thickness 2a of the at least one intermediate layer 20 (gap width), corresponding to FIG. 6. The different gyrotropy values g in FIGS. 6 and 7 are g=0.1 and g=0.05 and g=0.01.

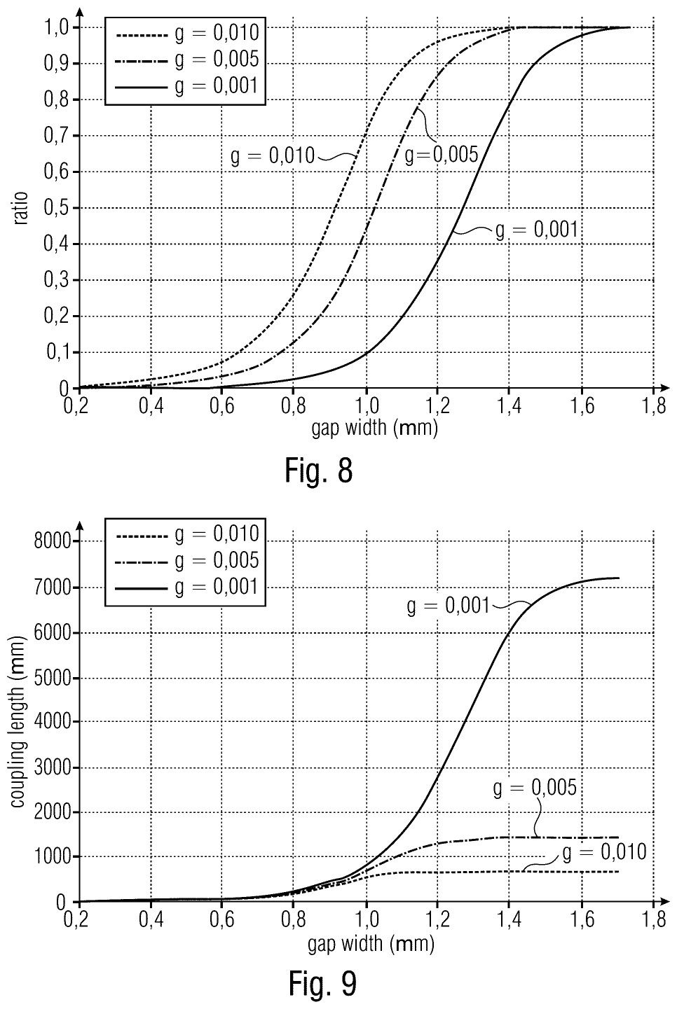

FIG. 8 shows a

$$ratio = \frac{{β}_{a} - {β}_{b}}{{β}_{e} - {β}_{o}}$$

of the two propagation constants βₐ, β_{b} and the even and odd modes βₑ, βₒ. The

$$ratio = \frac{{β}_{a} - {β}_{b}}{{β}_{e} - {β}_{o}}$$

was calculated for a constant thickness d (d indicates the width along the z-direction of a waveguide a, b) of the at least two waveguide layers 10 as a function of the at least one intermediate layer 20 (2a, gap width) for different gyrotropy values g. This ratio is shown in FIG. 8 in relation to the width 2a of the at least one intermediate layer 20 (gap width) for different gyrotropy values g. FIG. 9 shows a representation of the coupling length Lc, calculated for different gyrotropy values g as a function of the variation in thickness 2a of the at least one intermediate layer 20 (gap width), corresponding to FIG. 8. The different gyrotropy values g in FIGS. 8 and 9 are g=0.01 and g=0.005 and g=0.001.

From FIGS. 6 and 8, it may be seen that the

$$ratio = \frac{{β}_{a} - {β}_{b}}{{β}_{e} - {β}_{o}} )$$

varies between 0 and 1 for all gyrotropy values g. For a given intermediate layer width 2a, this value reaches 0.707107, which is the width at which a complete power exchange between waveguide a and b takes place.

From FIGS. 7 and 9, it may be seen that the quantity Lc increases with increasing intermediate width 2a for all gyrotropy values. Looking at a single case of gyrotropy, the following should be noted: When the width 2a of the intermediate layer reaches a certain value at which the calculated ratio is 0.707107, and when the optical input modes, i.e. the optical TM modes penetrating into a waveguide layer 10, cover a distance Lc, a complete power exchange takes place between the waveguides a and b.

The following values could be calculated: For g=0.1 against Lc=50.7 μm

For g=0.05 against Lc=101.4 μm

For g=0.01 against Lc=506.9 μm

For g=0,005 against Lc=1013.75 μm

For g=0.001 against Lc=5063.45 μm)

In FIGS. 6 to 9 it may be seen that the coupling length ranges from about Lc=50 μm for g=0.1 via Lc=500 μm for g=0.01 to Lc=5000 μm for g=0.001.

A thickness d of one of the at least two waveguide layers 10 is between 0.1 μm and 4 μm, in particular in two dimensions (2D) as well as in three dimensions (3D). The thickness d of one of the at least two waveguide layers 10 depends, for example, on the wavelength at which the multilayered signal guiding structure 100 is operated. The thickness d of one of the at least two waveguide layers 10 also depends, for example, on the materials used in the at least two waveguide layers 10. Single-mode waveguide layers 10 are used. In single-mode waveguide layers 10, a single mode is concentrated in the corresponding waveguide layer 10 if an electromagnetic signal is transmitted into the corresponding waveguide layer 10.

A thickness D of the MO material in the form of the at least two cover layers 30 or a thickness 2a of the MO material in the form of the at least one intermediate layer 20 may depend on the deposition technique used. The thickness may be between 50 nm and 500 nm.

In the present case, the term “thickness 2a, d or D” refers to a thickness in three dimensions. The term “thickness 2a, d or D” may also be understood as a diameter along the z-axis. In the figures shown, however, the thickness 2a, d or D is only shown in two dimensions.

The at least two waveguide layers 10 run parallel to each other along the direction of extension. In the present case, “parallel to each other” is to be understood in the sense of the possibility of producing waveguide layers 10 that are aligned as parallel to each other as possible. Production-related manufacturing defects in the at least two waveguide layers 10 may therefore also be understood as “parallel to each other”.

A thickness 2a of the at least one intermediate layer 20 is between 0.01 μm and 10 μm. In each of the three configurations described, the thickness 2a of the at least one intermediate layer 20 depends on the gyrotropy value g of the MO material used, provided that a MO material is used for the at least one intermediate layer 20. In FIGS. 7 and 9, for example, the thickness 2a of the at least one intermediate layer 20 is 2a=0.6 μm for g=0.1 or 2a=0.95 μm for g=0.01 or 2a=1.3 μm for g=0.001. In FIGS. 6 to 9 denotes the quantity “gap width” on the x-axis, i.e. the thickness 2a of the at least one intermediate layer 20.

The at least one intermediate layer 20 may also be provided by an air layer or SiO₂. However, air is not a MO material. In other words, air has no gyrotropy value g. When using the configuration shown in FIG. 2, the at least one intermediate layer 20 may also be provided by an air layer or SiO₂ or epoxy resin.

In particular, the at least one intermediate layer 20 does not exceed a thickness 2a of 100 μm. The value of 2a=100 μm may be understood as the maximum value of the thickness 2a of the at least one intermediate layer 20. Above such a value, coupled optical modes occur. The value of 2a=0.01 μm may be understood as the minimum value of the thickness 2a of the at least one intermediate layer 20. In particular, the minimum value may be any thickness 2a greater than zero.

A thickness D of one of the cover layers 30 is between 0.0 μm and 50 μm, in particular in the case of a chip, or between 0.0 μm to infinity, in particular if the multilayered signal guiding structure 100 is not integrated in a chip. The at least two cover layers 30 may also be configured as an air layer. In this case, the thickness D may be infinite. For a dielectric cover layer 30, the thickness D is at a minimum value greater than zero, for example D=0.01 μm, up to a maximum value of D=50 μm. In particular, the evanescent, i.e. decaying, field of a corresponding mode does not extend into the dielectric covering layer 30 over a length of more than 5 μm.

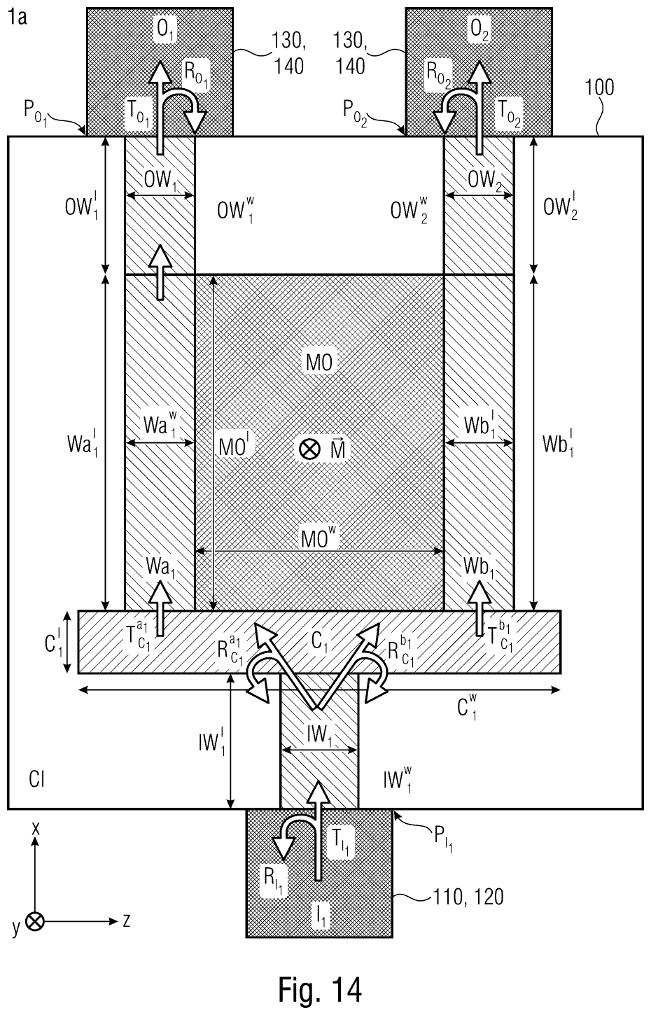

The multilayered signal guiding structure 100 comprises at least one input port 120 for introducing the electromagnetic signal and at least one output port 140 for outputting an output signal, wherein the input port 120 is configured to introduce coupled modes of the electromagnetic signal into the at least two waveguide layers 10 and the at least one output port 140 is configured to recouple the modes decoupled in the at least two waveguide layers 10 along the extension direction. The at least one input port 120 and the at least one output port 140 are shown, for example, in FIGS. 14 to 20.

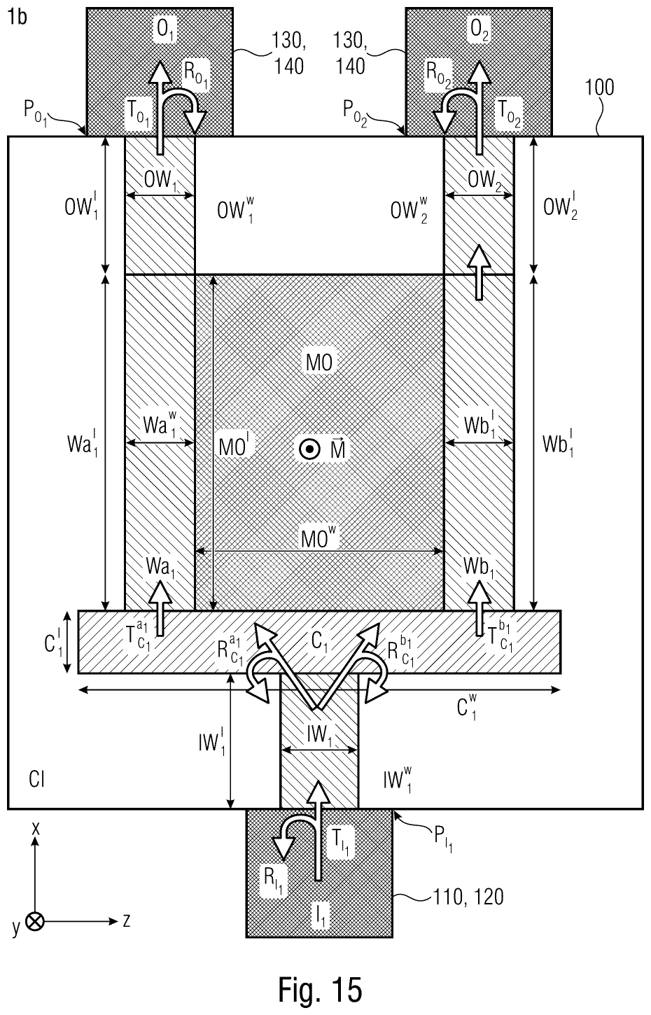

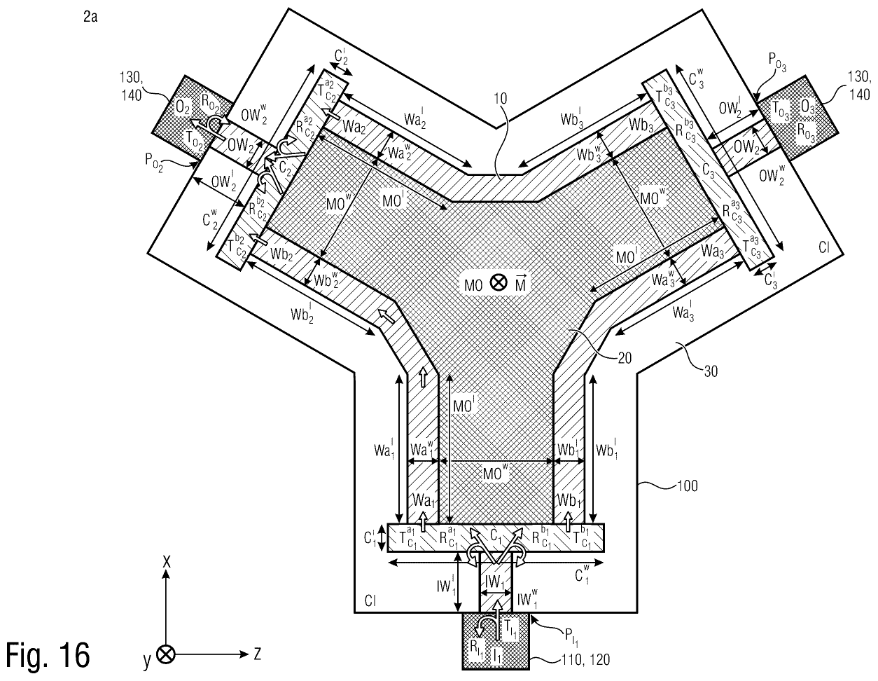

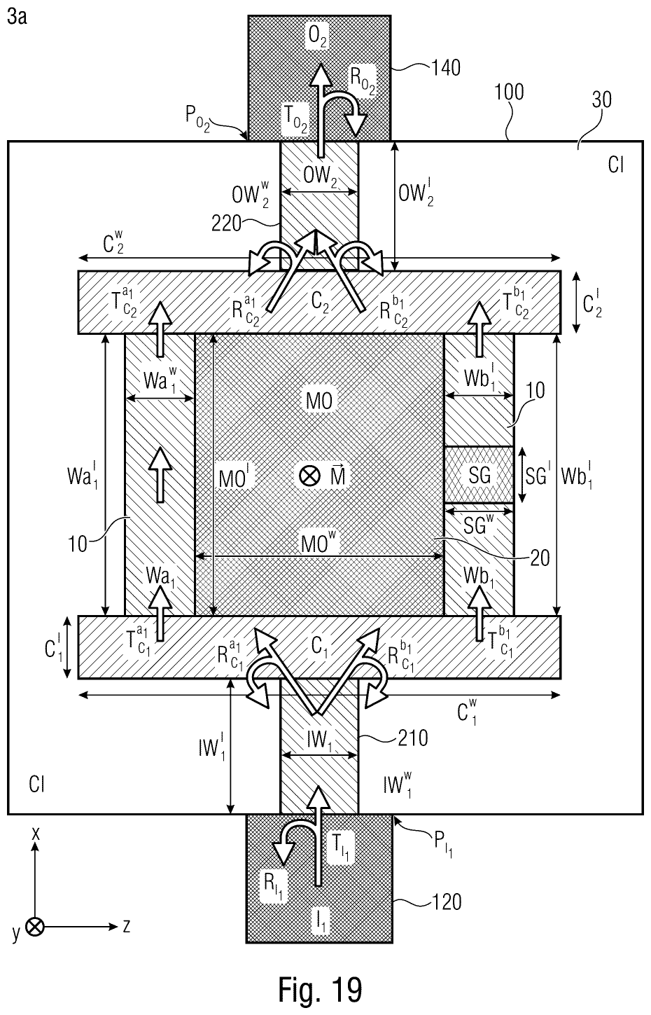

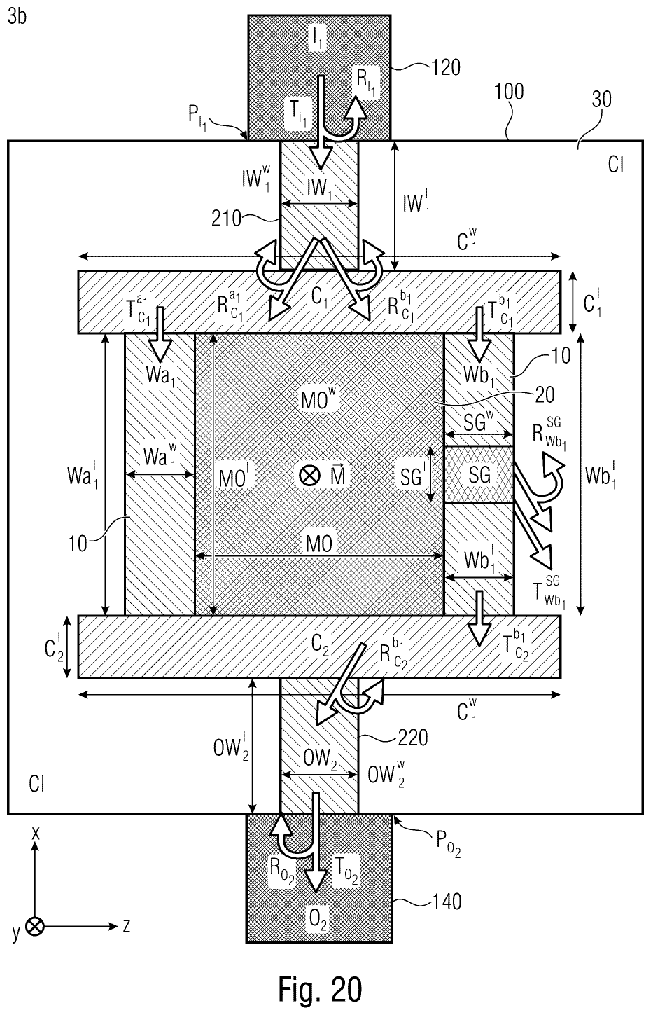

The multilayered signal guiding structure 100 may be configured by its structure to provide an isolation for, in particular optical, TM modes of an electromagnetic wave introduced into the at least two waveguide layers 10 (as shown, for example, in FIGS. 19 and 20) and/or to allow the TM modes, in particular optical modes, to propagate in the at least two waveguide layers 10 in a predetermined direction (see FIG. 19) and to prevent propagation in the direction opposite to the predetermined direction (as shown, for example, in FIGS. 14 and 15) and/or to circulate the, in particular optical, TM modes in the at least two waveguide layers 10 (as shown, for example, in FIGS. 16 to 18). In the present case, the term “structure” refers to a geometric and physical structure. At this point it should be noted that in 2D, only TM modes show this phenomenon, while in 3D TM and TE modes show this phenomenon.

In 2D, the switching, circulation and isolator effects are present when using the optical TM modes. In 3D mode, on the other hand, the operating mode may also include the optical TE mode, depending on the thickness of the MO layer and the waveguiding layers in the y-direction. In 3D, the TE and TM modes propagating in the at least two waveguide layers 10 depend on the geometric configuration of the multilayered signal guiding structure 100. This means: If the MO material has a low thickness in the y-direction, then the functionality is better developed in the TE mode than in the TM mode. If the MO material has a sufficient thickness in the y-direction, the functionality is better developed in the TM mode than in TE mode.

The terms “low thickness” and “sufficient thickness” are to be understood as follows. In 3D, the functionality of the multilayered signal guiding structure 100 depends on the MO material used. For example, some suppliers may deposit MO material with a thickness along the Y-axis of less than 100 nm. With such a thickness (small thickness) along the y-axis, the signal guiding structure 100 works better with TE modes. Other suppliers may deposit 500 nm from the MO material along the Y-axis. With such a thickness (sufficient thickness) along the y-axis, the signal guiding structure 100 works better with TM modes. To summarize, depending on the thickness of the MO material along the y-axis, a TE mode or a TM mode may be used to effect switching or isolation.

The proposed design of the multilayered signal guiding structure 100 can be used for both TE modes and TM modes in an isolator or in a switch or in a circulator. If needed, polarization converters positioned before or after the corresponding components may be used to convert the electromagnetic signal into a desired signal. The multilayered signal guiding structure 100 may be used as a switch (see FIGS. 14 and 15), or as a circulator (FIGS. 16 to 18 or as an isolator.

Multiport switching may be performed by stacking at least two multilayered signal guiding structures 100 in parallel in the z-direction.

In order to reduce the design footprint, stacking such signal guiding structures 100 in the y-direction could also be a way of utilizing them. Such a device could be of great interest to data centers, for example. Stacked multilayered signal guiding structures 100 are not shown in the attached figures.

The MO material may be partially or fully etched to provide space for a rib waveguide format and/or a ridge waveguide format. Garnet MO materials are considered hard materials. It is a delicate job to etch all the way down to the substrate in order to create a waveguiding structure. For this reason, rib waveguide constructions could also be a possible solution in place of ridge waveguides. In the rib configuration, the TMOKE acts in the same way on the coupled optical even and odd modes and changes the intensity profile of the magnetic field. Ridge waveguides are rectangular waveguides. Rib waveguides are rectangular waveguides with an additional layer of waveguiding material under the waveguide.

A single waveguide layer 10 comprises, for example, silicon and/or silicon nitride and/or silicon dioxide and/or a polymer and/or sol-gel. A single waveguide layer 10 may, for example, consist of only one of the materials mentioned. However, a single waveguide layer 10 may also consist of several of the aforementioned substances as a heterostructure or comprise several of the aforementioned substances.

The MO material may comprise or consist of garnet or doped garnet or doped silicon dioxide or sol-gel or ferromagnetic material. Each layer 20 and/or 30 comprises or consists of one of the aforementioned materials. In particular, the at least two cover layers 30 consist of or comprise the same or the same MO material. The at least two cover layers 30 may comprise a MO material with different, in particular opposite, magnetization directions or consist of the MO material with different, in particular opposite, magnetization directions than the at least one intermediate layer 20 with the condition that the applied external magnetization in the two regions is oriented in opposite directions. For example, according to FIGS. 3a and 3b, the MO material MO1 and the MO material MO2 may consist of the same MO material or MO1 comprises a different MO material than MO2. In any case, the external magnetic field in MO1 and MO2 should be opposite to each other in both cases.

A cover layer 30 may comprise or consist of silicon dioxide, SiO2, and/or air and/or polymethyl methacrylate, PMMA and/or PVA and/or SU-8. A single cover layer 30 may, for example, consist of only one of the aforementioned substances. However, a single cover layer 30 may also consist of several of the above-mentioned substances as a heterostructure or comprise several of the above-mentioned substances. SU-8 is a epoxy-based photoresist material. The name does not stand for anything in particular, but is a product designation of the manufacturer MicroChem, which developed this material.

The multilayered signal guiding structure 100 is arranged between a decoupling structure 110 for splitting an input signal at an input of the multilayered signal guiding structure 100 into signals of equal amplitude, and a coupling structure 130 for recoupling an output signal at an output of the multilayered signal guiding structure 100. The decoupling structure 110 may comprise the input port 120. The decoupling structure 110 comprises a splitter which allows the input signal to be split into signals of equal amplitude. Suitable distributors for the decoupling structure include, for example, a Y-junction or a multi-mode interference coupler (MMI), etc. The coupling structure 130 also comprises a splitter which enables the output signal, which comprises decoupled modes of the multilayered signal guiding structure 100, to be recoupled. Suitable distributors for the coupling structure 130 include, for example, a Y-junction or a multi-mode interference coupler (MMI) etc.

The input signal usually follows the following path in the signal routing structure 110:
1) For a switch or circulator: from input port 210, P_{I1} to the distributor (MMI, Y-junction . . . ), then cover a simple coupling length L_{C} in the waveguide layers 10, and then output an output signal at output ports 220, O1, O2
2) For an isolator: from input port 210, P_{I1} to the distributor (MMI, Y-junction . . . ), then cover twice the coupling length 2Lc in the waveguide layers 10, then to the coupler (inverse MMI, inverse Y-junction, . . . ) and then output of an output signal to the output port 220, O1, O2

The decoupling structure 110 and the coupling structure 130 may each be configured as a multi-mode interference coupler (MMI) or as a Y-junction or as a tree coupler or as a star coupler or as a directional coupler. Here, the decoupling structure 110 and the coupling structure 130 may both be of the same type, i.e. a multi-mode interference coupler (MMI) or a Y-junction or a tree coupler or a star coupler or a directional coupler. However, the decoupling structure 110 and the coupling structure 130 may also be of different types. For example, the decoupling structure 110 could be a multi-mode interference coupler (MMI) and the coupling structure 130 could be a directional coupler. Any combination of the decoupling/coupling structures mentioned is conceivable.

The decoupling structure 110 and the coupling structure 130 comprise an adiabatic coupler C₁ designed to avoid backward reflections. Adiabatic couplers C₁ are shown in FIGS. 14 to 20. An operating wavelength range of adiabatic couplers is known to be very large, which means that they could function optimized along a large wavelength spectrum, making them suitable for application purposes.

In the present case, the nomenclature R_{C}_{₁}^{a}^{₁}^{,b}^{₁} means that the coupler (whether combiner or splitter) may have backward reflections that may originate from both arms of the coupler. R therefore stands for the backward reflection, C1 for the first coupler and a1 and b1 for the waveguides. The nomenclature is also applicable to R_{C}_{₁}^{a}^{₁}^{,b}^{₁}, where T stands for the transfer of the power.

A waveguide layer 10 is configured as a straight waveguide running along the direction of extension, in particular along the x-axis, or as a curved waveguide or as a slotted waveguide or as an SWG waveguide or as a PhC waveguide or as a hybrid waveguide.

The theory behind the proposed invention is considered below. For reasons of simplicity and without limiting the generality, only five layers are considered below. The multilayered signal guiding structure 100 described above may comprise five layers or more than five layers.

Each of the configurations described here leads to similar or the same results.

The physical phenomena arising from such a geometry can be explained as follows: In traditional coupled waveguides (without MO materials or effects), even and odd coupled modes exist that do not exchange power when traveling simultaneously. Upon applying an external magnetization in TMOKE, on the five-layered heterostructure, coupled even and odd optical modes lose their conventional symmetric/anti-symmetric electromagnetic intensity profiles and become asymmetric and anti-asymmetric, respectively.

Due to the unbalanced intensity distribution, if the even mode is concentrated in waveguide a, then the odd mode will be concentrated in waveguide b. Additionally, these modes should propagate a distance known as the “coupling length” to decouple, leaving only one of them at the end with its power concentrated solely in one of the parallel waveguides.

The switch component (as shown in FIGS. 14 and 15) plays a crucial role in routing and managing data in optical networks, allowing for efficient and rapid switching of optical signals between different pathways. They are utilized in telecommunications, data centers, etc. Here, switches can be designed starting with a waveguide as an input port, hosting the, in particular optical, TM mode (fundamental modes or higher-order optical modes). A second element, a (de)coupler: Y-junction, MMI coupler, etc., (see above) splits the input waveguide into two parallel waveguides with MO material placed in between. At this point, coupled even and odd modes exist in the system, which de-couple at the end of the structure. Depending on the orientation of the external magnetization, light is concentrated in either of the waveguides, a or b. So far, the multilayered, in particular five-layered signal guiding structure allows for complete control over light propagation direction by manipulating the orientation of the external magnetization.

It is worth noting that an additional degree of freedom is the phase of the optical mode in the waveguides a and b. The even-asymmetrical mode has modal lobes that are in phase with each other, with the higher intensity lobe concentrated in the waveguide a. The odd-anti-asymmetric mode has phase-shifted modal lobes (π), with the higher intensity lobe concentrated in the waveguide b. This means that if the input modes are in phase (when excited by the optical TM fundamental mode), the even asymmetrical mode appears at the output port in the waveguide a. If, on the other hand, the input modes are out of phase (when excited by a second-order optical TM mode), the odd anti-asymmetrical mode appears at the output port in the waveguide b. Thus, in addition to using the external magnetic field direction to switch the light guide, the initial phase can also be used. In both cases, these modes should propagate for decoupling over a distance described as the “coupling length” L_{c} herein, so that in the end only one mode of them remains, whose power is concentrated exclusively in one of the parallel waveguides.

FIG. 14 shows a top view of a dielectric MO switch in which the direction of the applied external magnetic field is directed inwards. FIG. 15 shows a top view of a dielectric MO switch in which the direction of magnetization is directed outwards. Inward or outward refers to a direction into or out of the MO material in which the magnetization resulting from the external magnetic field is directed. If the direction of the external magnetic field is reversed, the magnetization is also reversed. As a result, the light then propagates in waveguide b instead of waveguide a. The switches in FIGS. 14 and 15 each have one input port 110 and two output ports 130. In addition, the switches in FIGS. 14 and 15 each have one decoupling structure 120 and two coupling structures 140. Furthermore, the switches in FIGS. 14 and 15 each have an adiabatic coupler C1. The reference signs of the multilayered signal guiding structure correspond to the reference signs in FIGS. 1 to 3, which will not be repeated here. It should be noted that in the switch shown in FIGS. 14 and 15, a cover layer 30 is partially arranged between the two signal guiding layers 10, namely where no MO material is arranged between the two signal guiding layers.

A circulator, such as that shown in FIGS. 16, 17 and 18, resembles a switch in functionality, yet distinguishes itself by accommodating a greater number of ports. A circulator's expanded capacity enables it to efficiently manage multiple connections with enhanced versatility. It can be designed by placing three switches at 120°-s rotated from each other. The description for the switches in FIGS. 14 and 15 therefore also applies to the circulators in FIGS. 16, 17 and 18 and will not be repeated.

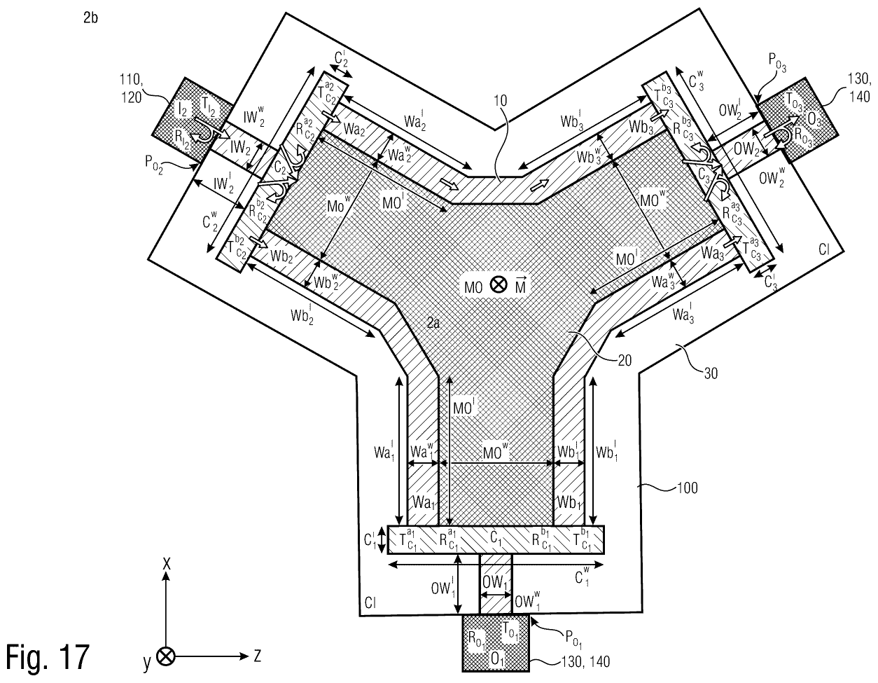

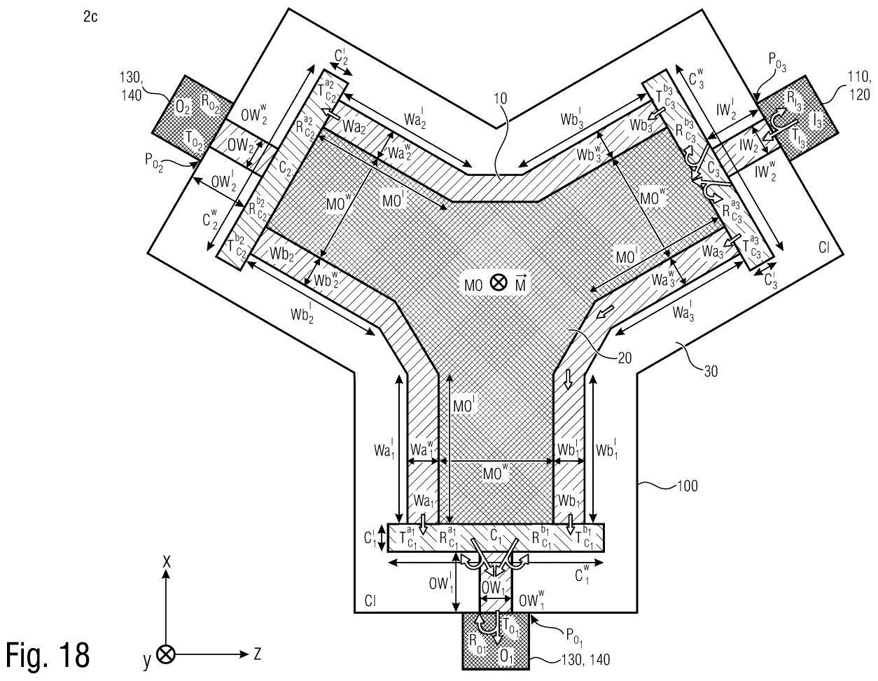

FIG. 16 shows a top view of a dielectric MO circulator with light entering through a first port I₁. FIG. 17 shows a top view of a dielectric MO circulator with light entering through a second port I₂. FIG. 18 shows a top view of a dielectric MO circulator with light entering through a third port I₃.

When the direction of the input light or input signal is switched from forward to backward, light will be concentrated in waveguide b, as if the external magnetization's orientation has switched. This concept enables the construction of optical isolators.

Optical isolators (such as those shown in FIGS. 19 and 20) act as a one-way gate for light, allowing signals to travel from the input to the output but preventing light from reflecting back into the source, i.e. in the opposite direction. Optical isolators are essential in various applications, including laser systems, fiber-optic communication networks, and optical instrumentation. By ensuring signal integrity and preventing laser destabilization, they contribute to the overall reliability and performance of optical systems.

FIG. 19 shows a top view of a dielectric MO isolator with light traveling in the forward propagation direction, i.e. from zero to +x. FIG. 20 shows a top view of a dielectric MO isolator with light traveling in the backward propagation direction, i.e. from −x to zero.

To develop an isolator, an input waveguide 210, a (de)coupler C1, a multilayered, in particular five-layered signal guiding structure 100, a coupler C2 and an output waveguide 220 are used. The optical TM mode is decoupled and recoupled to the output. This design confines the input light (optical TM mode) to waveguide a, in particular a waveguide a, in the forward direction and to waveguide b, in particular a waveguide b, in the backward direction. Finally, for this to operate non-reciprocally, the collected power at the input and output ports 110, 130 is to be unequal. To achieve this, it is sufficient to use any element that generates interference so that it does not cause back reflections. A radiating SWG waveguide (SWG=sub-wavelength grating) is proposed. The SWG waveguide is placed at the center of the waveguide b to diffract the light outwards. In this context, ring resonators may also be used to deflect light, providing a versatile mechanism for deflecting light to the rear.

If the SWG waveguide is designed with the correct pitch in relation to the waveguide b and the correct fill factor, the SWG waveguide operates in a radiation mode. This means that the light outside a guide area SG is diffracted by the SWG waveguide (SG in FIGS. 19 and 20). If the ring resonator is carefully designed and has the correct dimensions, the ring resonator can efficiently guide light out of the waveguide.

In this arrangement, light can pass undisturbed in the forward direction, while light is scattered outward in the reverse direction, resulting in an imbalance of power collected at the opposing input and output ports 110, 130. The SWG is an array of grids that have geometric properties that may be summarized by division and fill factor. The ring resonator is a resonator with a high quality, which is defined by parameters such as radius, circumference and coupling coefficient.

To summarize, the MO effect on the coupled optical modes enables the selection of the light propagation direction, allowing switches/circulators to be created. In combination with additional elements such as SWGs or resonators, these radiate the backward signal to the outside and thus form an isolator. As will now become clear, the proposed invention is a highly efficient solution for integrable optical switches/circulators and isolators in PICs. The design promises 100% switching/circulation and/or insulation when it is used.

The various elements that make up the switch, the circulator and the isolator are of low complexity. The theory behind straight waveguides (input and output) and couplers (regular or inverse) is already known and clear and will not be described in detail here. The segment that deserves the most attention is the core area, namely the multilayered signal guiding structure 100.

A theoretical approach for the multilayered signal guiding structure 100 is presented below.

### Modal Analysis

The work completed for this invention is done theoretically using Maxwell's equations and supported by FDTD as well as FEM simulations. As discussed thoroughly, using MO materials is an efficient way to break time symmetry. Almost all MO phenomena are a direct consequence of the Zeeman Effect.

The dielectric tensor of such MO material can be represented in the form [40].

$${ε}_{d} = ( \begin{matrix}{ε}_{xx} & {ε}_{xy} & {ε}_{xz} \\ {ε}_{yx} & {ε}_{yy} & {ε}_{yz} \\ {ε}_{zx} & {ε}_{zy} & {ε}_{zz}\end{matrix} )$$

Each pair of these non-diagonal elements are equal and opposite in magnitude (ε_{xy}=−ε_{yx}, ε_{xz}=−ε_{zx}, ε_{yz}=−ε_{zy}). In the absence of an external magnetic field, this tensor could be written as a diagonal one where the three elements are equal to each other (εₓₓ=ε_{yy}=ε_{zz}).

The off-diagonal element is given by:

$${ε}_{xy} = i \cdot g = i \cdot {n}_{MO} \cdot {θ}_{F} / π$$

Where: g is the MO gyrotropic parameter, εₐ is the dielectric constant, λ is the wavelength of operation and θ_{F} is the associated Faraday rotation coefficient. The parameter g is usually very small at optical wavelength (<10⁻²). For example, bismuth iron garnet (BIG) exhibits g≈0.06 [41]. With reference to FIGS. 6 to 9, g is also referred to as the gyrotropy level.

For the sake of simplicity in the theoretical derivations, analysis and numerical simulations, and without loss of generality, we assume our system to be a two-dimensional structure, i.e. without field variations in the y-direction. Note that, in our analysis we keep the material permittivities independent of frequency. This does not introduce any limitation in our concept, since if needed, the dispersion of the material parameters can be easily included in the original design of the system.

Using Maxwell's equations, we derive the generalized dispersion relations. A top view of the multilayered signal guiding structure 100 in the form of a five-layer signal guiding structure is shown in FIG. 1. FIG. 1 shows a MO material with the width/thickness 2a and two, in particular dielectric, waveguides a and b with the width d respectively. This type of structure can host the even and odd coupled modes. These eigenmodes arise from evanescent coupling between the optical modes supported by the individual waveguides a and b which propagate in the x-direction.

In a Cartesian coordinate system the electromagnetic fields can be represented as:

$$\begin{matrix}\vec{E} = \vec{{E}_{0}} {e}^{i ( ω t - β x )} \\ \vec{H} = \vec{{H}_{0}} {e}^{i ( ω t - β x )}\end{matrix} ,$$

Where \vec{E₀} and \vec{H₀} are the amplitude vectors with complex-valued components. β is the propagation constant of the traveling waves and corresponds to the component of the wave vector in the direction of propagation and ω=2πf is the angular frequency of the incident wave.

Choosing reasonable modal field functions in each region of the waveguide and employing the electromagnetic field boundary conditions, the modal field solution and the characteristic equation can be obtained. The magnetic field components in the considered five layers can be written in the following form, where 2a stands for the thickness of the at least one intermediate layer 20 and d for the density of a waveguide layer 10:

$${H}_{y} ( z ) = \{ \begin{matrix}{A}_{1} exp [ - {K}_{1} ( z - a - d ) ] z \geq a + d \\ {A}_{2} cos [ {K}_{2} ( z - a - d / 2 ) ] a \leq z \leq a + d \\ {A}_{3} exp \{ {K}_{3} z ] + {A}_{4} exp [ - {K}_{3} z ] - a \leq z \leq a \\ {A}_{5} cos [ {K}_{4} ( z + a + d / 2 ) ] - a - d \leq z \leq - a \\ {A}_{6} exp [ {K}_{5} ( z + a + d ) ] z \leq - a - d\end{matrix}$$

By replacing H_{y} of each layer into the wave equation, one can find the expression for the wavevectors in each layer of the considered structure.

$${K}_{1 , 3 , 5} = \sqrt{( {β}_{e , o}^{2} {γ}_{xx}^{1 , 3 , 5} - {k}_{0}^{2} ) / {γ}_{xx}^{1 , 3 , 5}} , {K}_{2 , 4} = \sqrt{( {k}_{0}^{2} - {β}_{e , o}^{2} {γ}_{xx}^{2 , 4} ) / {γ}_{xx}^{2 , 4}} ,$$

$$Where :$$

$${γ}_{zx}^{3} = ig / ( {n}_{3}^{4} - {g}^{2} ) , {γ}_{xx}^{3} = {n}_{3}^{2} / ( {n}_{3}^{4} - {g}^{2} )$$

$${γ}_{xx}^{1 , 5} = 1 / {n}_{1 , 5}^{2} , {γ}_{xx}^{2 , 4} = 1 / {n}_{2 , 4}^{2}$$

Finally, applying the continuity of the electromagnetic fields Eₓ, H_{y} and E_{z} at the different boundaries (−a−d, −a, +a, +a+d), for this wave, the complex dispersion relation is written in the following way:

$${K}_{2} d = {tan}^{- 1} ( \frac{{γ}_{xx}^{1} {K}_{1}}{{γ}_{xx}^{2} {K}_{2}} ) + {tan}^{- 1} ( \frac{{A}_{3} exp [ {K}_{3} a ] ( {β}_{e , o} {γ}_{zx}^{3} - i {γ}_{xx}^{3} {K}_{3} ) + {A}_{4} exp [ - {K}_{3} a ] ( {β}_{e , o} {γ}_{zx}^{3} + i {γ}_{xx}^{3} {K}_{3} )}{- i {γ}_{xx}^{2} {K}_{2} ( {A}_{3} exp [ {K}_{3} a ] + {A}_{4} exp [ - {K}_{3} a ] )} )$$

$$Where :$$

$${A}_{3} = \frac{- 2 {βγ}_{zx}^{3} cos h ( 2 {K}_{3} a ) {A}_{4} \pm \sqrt{{( 2 {β}_{e , o} {γ}_{zx}^{3} cos h ( 2 {K}_{3} a ) {A}_{4} )}^{2} - 4 ( {β}_{e , o} {γ}_{zx}^{3} - i {γ}_{xx}^{3} {K}_{3} ) ( {β}_{e , o} {γ}_{zx}^{3} + i {γ}_{xx}^{3} {K}_{3} ) {A}_{4}^{2}}}{2 ( {β}_{e , o} {γ}_{zx}^{3} - i {γ}_{xx}^{3} {K}_{3} )}$$

In the second equation, the two solutions obtained from the “plus” and “minus” signs correspond to the propagation constants of the even and odd modes β_{e,o} respectively. From the relation of A₃ to A₄, it is evident that the amplitudes of the H_{y}(z) component, corresponding to each of the coupled modes, A₂ and A₅ in the waveguides a and b, respectively are different. Therefore, we can conclude that the even and odd coupled modes lose their traditional symmetric behavior and become asymmetric and anti-asymmetric, respectively, around the z-axis.

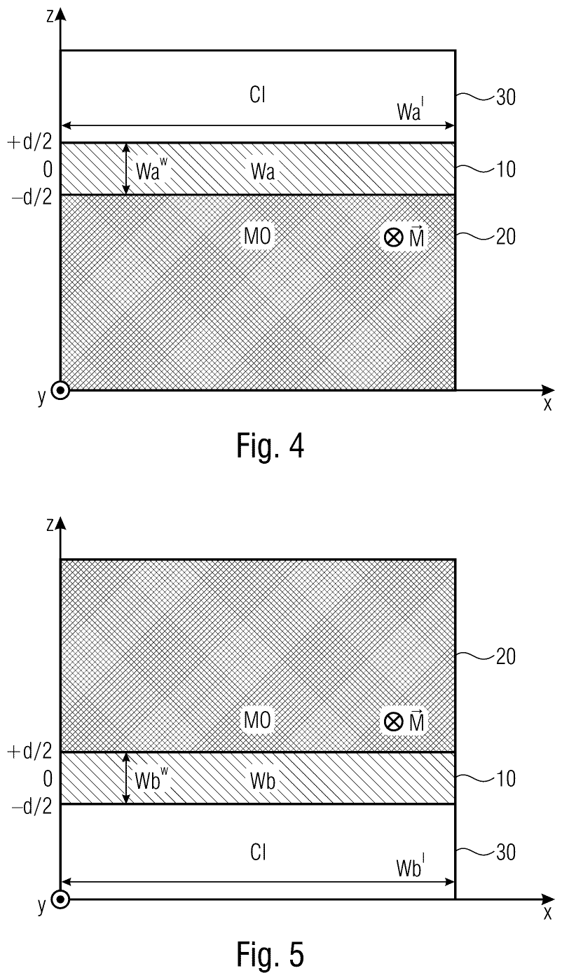

When the width of the MO layer becomes too wide the system can be broken down into two sections. FIGS. 4 and 5 represent the two partitions.

FIG. 4 shows a top view of a first partition of the multilayered signal guiding structure 100 with only one waveguide layer 10, i.e. waveguide a. FIG. 5 shows a top view of a further partition of the multilayered signal guiding structure 100 with only one waveguide layer 100, i.e. waveguide b.

For the three-layered signal guiding structure in FIG. 4, the magnetic field components in the waveguide a can be written in the form:

$${H}_{y} ( z ) = \{ \begin{matrix}{A}_{1} exp [ - {K}_{1} ( z - d / 2 ) ] z \geq d / 2 \\ {A}_{2} cos [ {K}_{2} ( z ) ] - d / 2 \leq z \leq d / 2 \\ {A}_{3} exp [ {K}_{3} ( z + d / 2 ) ] z \leq - d / 2\end{matrix}$$

Dispersion relation:

$${K}_{2} d = {tan}^{- 1} ( \frac{{γ}_{xx}^{3} {K}_{3}}{{γ}_{xx}^{2} {K}_{2}} ) + {tan}^{- 1} ( \frac{{β}_{a} {γ}_{zx}^{1} + i {γ}_{xx}^{1} {K}_{1}}{i {γ}_{xx}^{2} {K}_{2}} )$$

βₐ represents the propagation constant of the fundamental mode of waveguide a.

For the three-layered signal guiding structure 100 of FIG. 5, the magnetic field components in waveguide b can be written in the form:

$${H}_{y} ( z ) = \{ \begin{matrix}{A}_{1} exp [ - {K}_{1} ( z - d / 2 ) ] z \geq d / 2 \\ {A}_{2} cos [ {K}_{2} ( z ) ] - d / 2 \leq z \leq d / 2 \\ {A}_{3} exp [ {K}_{3} ( z + d / 2 ) ] z \leq - d / 2\end{matrix}$$

Dispersion relation:

$${K}_{2} d = {tan}^{- 1} ( \frac{{γ}_{xx}^{3} {K}_{3}}{{γ}_{xx}^{2} {K}_{2}} ) + {tan}^{- 1} ( \frac{{β}_{a} {γ}_{zx}^{1} + i {γ}_{xx}^{1} {K}_{1}}{i {γ}_{xx}^{2} {K}_{2}} )$$

β_{b} represents the propagation constant of the fundamental mode of waveguide b.

The derived relations exhibit that the propagation constants in the two cases are different βₐ≠β_{b}. This is indeed due to the presence of the MO layer, leading to breaking spatial symmetry.

### Coupled Mode Theory in the Multilayered, in Particular Five-Layered, Signal Guiding Structure

The Coupled-Mode Theory (CMT) is useful in understanding the coupling mechanisms in parallel waveguides. CMT assumes that the coupled modes can be expressed as a linear combination of the individual modes in the uncoupled waveguides a, b and it involves solving a set of equations to determine the amplitudes and propagation constants of the coupled modes. The coupling between the modes is described by coefficients K_{ab} und K_{ba}, which quantify the strength of the interaction. It suffices to use the equations present in [42]. Expressed in a matrix form:

$$( \begin{matrix}{P}_{1} ( x ) \\ {P}_{2} ( x )\end{matrix} ) = ( \begin{matrix}cos ( ψ x ) - i \frac{Δ}{ϕ} sin ( ψ x ) & i \frac{{K}_{ba}}{ψ} sin ( ψ x ) \\ i \frac{{K}_{ba}}{ψ} sin ( ψ x ) & cos ( ψ x ) - i \frac{Δ}{ϕ} sin ( ψ x )\end{matrix} ) {e}^{\frac{i ( {β}_{a} + {β}_{b} )}{2} x} ( \begin{matrix}{P}_{1} ( 0 ) \\ {P}_{2} ( 0 )\end{matrix} )$$

There are two eigenvalues for β: βₑ and βₒ for the even (βₑ where e stands for even) and odd modes (βₒ where o stands for odd):

$$\begin{matrix}{β}_{e , o} = \frac{{β}_{a} + {β}_{b}}{2} \pm ψ \\ Δ = \frac{{β}_{a} - {β}_{b}}{2} \\ ψ = \sqrt{{Δ}^{2} + {K}_{ab} {K}_{ba}}\end{matrix}$$

The coupling length can be written as a function of the propagation constants of the even and odd modes:

$${L}_{c} = \frac{π}{{β}_{e} - {β}_{o}}$$

In the presence of MO material, at x=0, the optical power is incident on both waveguides, i.e. P₁(0)=P₂(0)=0.5. The power at any point along the propagation axis (i.e. along the extension direction) can be extracted from the matrix:

$$\begin{matrix}{P}_{1} ( x ) = 0.5 [ cos ( ψ x ) - i \frac{Δ}{ψ} sin ( ψ x ) + i \frac{{K}_{ab}}{ψ} sin ( ψ x ) ] {e}^{\frac{i ( {β}_{a} + {β}_{b} )}{2} x} \\ {P}_{2} ( x ) = 0.5 [ cos ( ψ x ) + i \frac{Δ}{ψ} sin ( ψ x ) + i \frac{{K}_{ba}}{φ} sin ( ψ x ) ] {e}^{\frac{i ( {β}_{a} + {β}_{b} )}{2} x}\end{matrix}$$

The maximum power transfer between waveguide a and b occurs at L_{c}, where ψx=π/2. If we assume the power transferred is complete, then the ratio of the normalized power difference can be written:

$$Ratio = \frac{{{P}_{2} ( x )}^{2} - {{P}_{1} ( x )}^{2}}{{{P}_{2} ( x )}^{2}} = 1$$

Replacing each with its equivalent term and after simplification we get:

$$Ratio = \frac{{β}_{a} - {β}_{b}}{{β}_{e} - {β}_{o}} = 0.707107$$

This means when the ratio is 0.707107, complete power transfer occurs. For the purpose of demonstrating the principle, we have adopted the following values for material and geometrical parameters.

The variables d and 2a describe the thickness 2a of the intermediate layer 20 and the thickness d of a waveguide layer 10. The values g describe gyrotropy levels. The value n_{cladding} indicates a refractive index of a cover layer 30. The value n_{MO} indicates a refractive index of the intermediate layer 20, which in the present example comprises the MO material. The value n_{waveguide} indicates the refractive index of a waveguide layer 10, a, b. The terms “waveguide” and “waveguide layer” are used synonymously here. The derivation shown here was made for the first configuration according to FIG. 1. For the second and third configurations, the derivation is carried out in the same way and leads to similar results. In particular, the ratio and the coupling length Lc result in the same equation for these other configurations, which have been derived here.

Table 1 shows the parameters used to generate the graphs shown in FIGS. 6 to 9. These parameters indicate typical values for the cover layers 30, the waveguide layers 10 and the MO materials.

TABLE 1
Five-layered heterostructure variables and possible values.

| Variable | Value |
|---|---|
| n_{cladding} | 1.45 |
| n_{waveguide} | 3.48 |
| n_{MO} | 2.3 |
| g | 0.001, 0.05, 0.01, 0.05, 0.1 |
| 2a | [0.2-1.7] μm |
| d | 0.3 μm |

Using numerical methods one can solve the dispersion relations presented above and deduce the propagation constants β_{a,b} and β_{e,o}. To avoid plotting complexity, we have divided the results into two sets, for g, varying between [0.1-0.01] and [0.01-0.001]. These results are shown in FIGS. 6 to 9.

In FIGS. 6 to 9 it may be seen that the coupling length ranges from about Lc=50 μm for g=0.1 via Lc=500 μm for g=0.01 to Lc=5000 μm for g=0.001.

The results from FIGS. 6 to 9 show that for all g values, the ratio Ratio) increases with increasing interlayer 20, which could also be referred to as gap width. For each value of g, the Ratio reaches the value 0.707107 at a certain width (see FIGS. 7 and 9). For higher gap widths, β_{e,o} grow closer together, meaning a higher coupling length L_{C} is needed to reach the point of complete power transfer, in particular for Lc=506.9 μm, which may be seen in FIGS. 7 and 9. For MO material similar to BIG or Ce: YIG, g≈0.06 for which the Ratio reaches the needed value for 2a=0.72 μm, this corresponds to a L_{c}≈100 μm. Utilizing such a structure can lead to I. R>30 dB with minimal I.L<1 dB.

For even lower g, the L_{c} further increases, however this poses no consequence on the I.L; if silicon or silicon nitride is used as waveguiding material, the losses are in the range of a few db/cm.

### Optical Switch/Circulator

The optical switches 1a (see FIG. 14) and 1b (see FIG. 15) refer to the orientation of the external magnetization inwards and outwards. The optical circulators 2a, 2b and 2c are shown in FIGS. 16, 17 and 18. The FIGS. 14 to 18 each show a 2D top view of the proposed design and the path of electromagnetic signal propagation (see bold arrows in FIGS. 14 to 18) in any case.

For the optical switch 1a in FIG. 14, the applied external magnetic field is directed inwards. The signal starts from a region I₁ which could be a laser source or a PIC, for example. While transversing from the input region to the input waveguide 210, IW₁ of dimensions (IW₁^{w}, IW₁^{l}) μm through the port P_{I}_{₁}, negligible backward reflections (B.R) are foreseen and can be quantified as R_{I}_{₁}. The remaining normalized signal, T_{I}_{₁} is split into two equal signals using an adiabatic coupler C₁, of dimensions (C₁^{w}, C₁^{l}) μm. The coupler should be designed to avoid, B.R, R_{C}_{₁}^{a}^{₁}^{,b}^{₁}, which can occur at this interface. The equally split signals R_{C}_{₁}^{a}^{₁}^{,b}^{₁} enter waveguides a and b of dimensions (Wa₁^{w}, Wa₁^{l}) μm and (Wb₁^{w}, Wb₁^{l}) μm. Here, the MO material is placed in the intermediate layer 20 between the waveguides a, b of dimension (MO₁^{w}, MO₁^{l}) μm and the cover layers 30, also called Cl cladding layer, on the outside. This is the interaction region where the even and odd coupled modes in the presence of external magnetization exchange power. At the end, i.e. after propagation over a distance corresponding to the coupling length, a maximum, in particular the entire, power is concentrated in the waveguide a, and a minimum, in particular no, power remains in the waveguide b. B.R can also be expected as R_{O}_{₁}, if T_{O}_{₁} from the output waveguide OW₁ of dimensions (OW₁^{w}, OW₁^{l}) μm runs through the port P_{O}_{₁} to the output region O₁.

If the external magnetization is switched and oriented from the inside to the outside, the same phenomenon occurs (see FIG. 15). In this case, however, the light is concentrated after propagation via a coupling path in the waveguide b. The output signal T_{O}_{₂} runs from the output waveguide OW₂ of dimensions (OW₂^{w}, OW₂^{l}) μm through the port P_{O}_{₂} to the output region O₂.

In FIG. 10, the power P in the at least two waveguide layers 10 (i.e. waveguide a (black) and b (gray)) of the multilayered signal guiding structure 100 is shown as a function of the coupling length Lc in the forward direction, in particular which is used, for example, in a switch or a circulator. FIG. 10 shows that as the coupling length Lc increases, the concentration of power P in the waveguide a increases, while at the same time it decreases in the waveguide. With a coupling length of approximately Lc=500 μm, the power P is maximum in waveguide a and minimum in waveguide b.

In the case of a circulator (see FIGS. 16 to 18), there are three ports with a fixed external magnetization orientation. Following the same description as for the switch, the input signal from P_{I}_{₁} is output by P_{O}_{₂}. If the second port, P_{I}_{₂} is energized, then the output signal from P_{O}_{₃} is collected. When the third port, P_{I}_{₃} is finally energized, the output signal from P_{O}_{₁} is collected. For reasons of redundancy, no further description of the circulators is provided, as the description of the switches can be applied by analogy.

### Optical Isolator

The optical isolator, 3a (see FIG. 19) and 3b (see FIG. 20), has a propagation direction in the forward and backward direction respectively, wherein the forward direction in FIG. 19 is represented by the bold arrows along the +x-axis and the backward direction in FIG. 20 is represented by the bold arrows along the −x-axis. FIGS. 19 and 20 each show a 2D top view of the proposed design and the path of electromagnetic signal propagation (see bold arrows) in each sense.

In the forward direction, signal starts from region I₁, which can be a laser source or a PIC. While transversing from the input region to the input waveguide 210, IW₁ of dimensions (IW₁^{w}, IW₁^{l}) μm through the port P_{I}_{₁}, negligible B.R are foreseen and can be quantified as R_{I}_{₁}. The remaining normalized signal, T_{I}_{₁} is split into two equal signals using an adiabatic coupler C₁ of dimensions (C₁^{w}, C₁^{l}) μm. The coupler should be designed to avoid B.R which can also occur at this interface R_{C}_{₁}^{a}^{₁}^{,b}^{₁}. The equally split signals T_{C}_{₁}^{a}^{₁}^{,b}^{₁} enter waveguides a and b of dimensions (Wa₁^{w}, Wa₁^{l}) μm and (Wb₁^{w}, Wb₁^{l}) μm. Here, the MO material from the intermediate layer 20 is placed between the waveguides 10, a, b of dimension (MO₁^{w}, MO₁^{l}) μm, and the cover layers 30, also called Cl cladding layer, on the outside. This is the interaction region where the even and odd coupled modes in the presence of external magnetization exchange power. At the middle, after the first coupling length all the power will be concentrated in waveguide a. After propagating another coupling length, the signal will evanescently couple back to waveguide b. At this point, the signals are of equal intensity T_{C}_{₁}^{a}^{₁}^{,b}^{₁} and combine by the second coupler C2 of dimensions (C₂^{w}, C₂^{l}) μm to produce a single signal. B.R can also be expected due to the recombination of the signals R_{C}_{₂}^{a}^{₁}^{,b}^{₁}. Then T_{O}² passes from the output waveguide 220, OW₂ of dimensions (OW₂^{w}, OW₂^{l}) μm through the port P_{O}_{₂} to the output region O₂, which can be another optical component or a PIC. Assuming no I.L by the dielectric waveguides is provided and minimal B.R, the forward transmission is T_{O}_{₂}^{f}≈1.

In the backward forward sense, signal starts from region I₁, which can be an optical component or a PIC, for example. While transversing from the input region to the input waveguide 210, IW₁ of dimensions (IW₁^{w}, IW₁^{l}) μm through the port P_{I}_{₁}, negligible B.R are foreseen and can be quantified as R_{I}_{₁}. The remaining normalized signal, T_{I}_{₁} is split into two equal signals by using an adiabatic coupler C₁ of dimensions (C₁^{w}, C₁^{l}) μm. The coupler should be designed to avoid B.R which can also occur at this interface R_{C}_{₁}^{a}^{₁}^{,b}^{₁}. The equally split signals T_{C}_{₁}^{a}^{₁}^{,b}^{₁} enter waveguides a und b of dimensions (Wa₁^{w}, Wa₁^{l}) μm and (Wb₁^{w}, Wb₁^{l}) μm. Here, the multilayered, in particular five-layered signal structure is formed with the MO material placed in the intermediate layer 20 between the waveguides 10, a, b of dimension (MO₁^{w}, MO₁^{l}) μm, and the cover layers 30, also called a Cl cladding layer, on the outside. This is the interaction region where the even and odd coupled modes in the presence of external magnetization exchange power. At the middle, after the first coupling length all the power will be concentrated in waveguide b. In this region, a SWG or a resonator is placed with dimensions SG of dimensions (SG^{w}, SG^{l}) μm. By designing the pitch and filling factor in a correct manner, the SG will radiate the optical mode outwards. In this way, no light couples in C₂ and no light reaches the output waveguide and the port system. Assuming the light is completely radiated by the gratings, backward transmission is T_{O}_{₂}^{f}≈0.

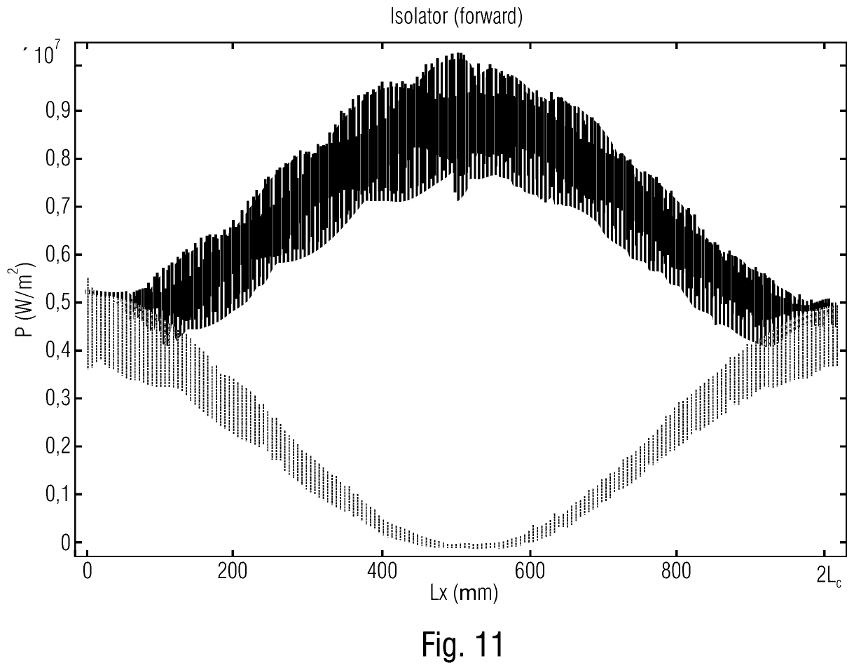

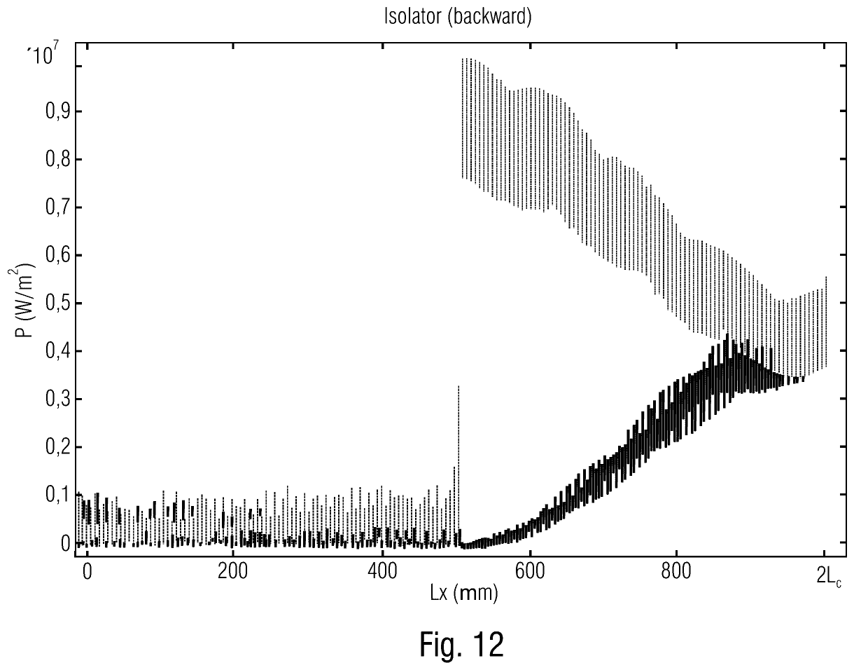

As we can see, the forward and backward transmissions are different from each other. This results in a component with high efficiency: high I.R, low I.L and low B.R. In FIG. 11, the power P in the at least two waveguide layers (waveguide a (black) and b (gray)) of the multilayered signal guiding structure 100 is shown in the forward direction as a function of the double coupling length 2Lc, which is used, for example, in an isolator. FIG. 11 shows that when the single coupling length Lc (at about 500 μm) is reached, the power P in waveguide a is maximum, i.e. concentrated, while in waveguide b the conduction P is minimum. At twice the coupling length 2Lc, waveguide a and waveguide b have the same power. In FIG. 12, the power P in the at least two waveguide layers (waveguide a (black) and b (gray)) of the multilayered signal guiding structure 100 is shown in the backward direction as a function of the double coupling length 2Lc, which is used, for example, in an isolator.

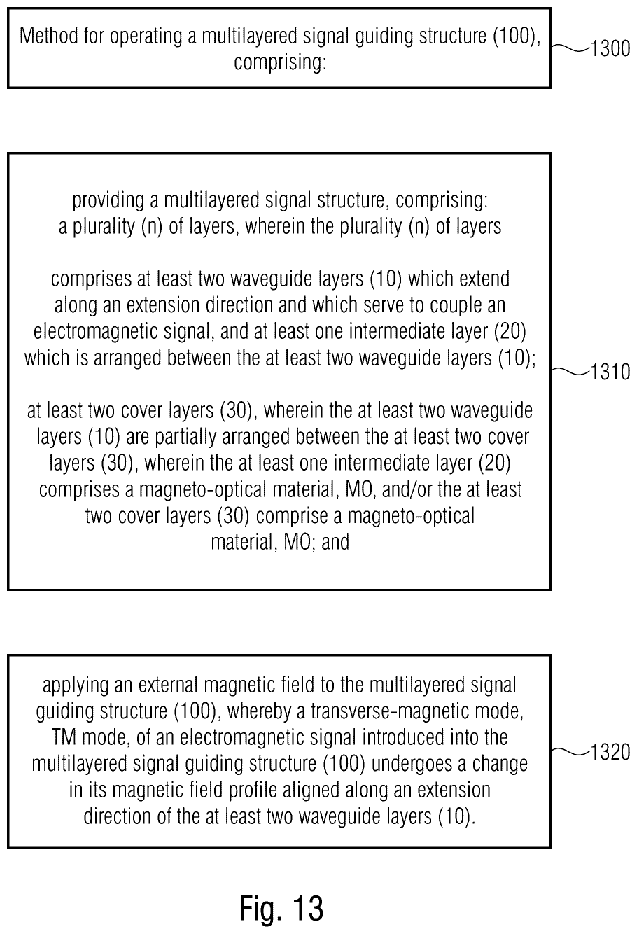

Another aspect of the present invention relates to a method 1300 for operating a multilayered signal guiding structure 100, in particular with a multilayered signal guiding structure 100 described herein. The method 1300 is shown in FIG. 13 as a flow chart. The method 1300 comprises, in step 1310, providing a multilayered signal structure, comprising: a plurality n of layers, the plurality n of layers comprising at least two waveguide layers 10, which extend along an extension direction and which serve to couple an electromagnetic signal, and at least one intermediate layer 20 that is arranged between the at least two waveguide layers 10; and at least two cover layers 30, wherein the at least two waveguide layers 10 are partially arranged between the at least two cover layers 30, wherein the at least one intermediate layer 20 comprises a magneto-optical material, MO, and/or the at least two cover layers (30) comprise a magneto-optical material, MO. In step 1310, in particular, a multilayered signal guiding structure 100 described herein is provided. All the explanations already made with regard to the multilayered signal guiding structure 100 can be interpreted as method step 1310, which, however, are not described again below as method steps for reasons of redundancy. In step 1320, the method 1300 comprises applying an external magnetic field to the multilayered signal guiding structure 100, whereby a transverse-magnetic mode, TM mode, or a transverse-electric mode, TE mode, of an electromagnetic signal introduced into the multilayered signal guiding structure 100 undergoes a change in its electromagnetic field profile aligned along an extension direction of the at least two waveguide layers 10. Step 1310 has to be carried out before step 1320. In the proposed method, coupled modes are first decoupled and concentrated in a waveguide layer 10, for example in waveguide a, either alone or predominantly. The decoupled modes are finally recoupled in the form of an output signal. The output signal can then be further processed.

Depending on the orientation of the external magnetic field to the multilayered signal guiding structure 100, the electromagnetic signal is concentrated in only one of the at least two waveguide layers 10. The concentration of the electromagnetic signal in only one of the at least two waveguide layers 10 may be seen, for example, in FIGS. 10, 11 and 12.

In FIG. 10, the power P in the at least two waveguide layers 10 (i.e. waveguide a (black) and b (gray)) of the multilayered signal guiding structure 100 is shown as a function of the coupling length Lc in the forward direction, in particular which is used, for example, in a switch or a circulator. FIG. 10 shows that as the coupling length Lc increases, the concentration of power P in the waveguide a increases, while at the same time it decreases in the waveguide. With a coupling length of approximately Lc=500 μm, the power P is maximum in waveguide a and minimum in waveguide b.

In FIG. 11, the power P in the at least two waveguide layers (waveguide a (black) and b (gray)) of the multilayered signal guiding structure 100 is shown in the forward direction as a function of the double coupling length 2Lc, which is used, for example, in an isolator. FIG. 11 shows that when the single coupling length Lc (at about 500 μm) is reached, the power P in waveguide a is maximum, i.e. concentrated, while in waveguide b the conduction P is minimum. At twice the coupling length 2Lc, waveguide a and waveguide b have the same power.

In FIG. 12, the power P in the at least two waveguide layers (waveguide a (black) and b (gray)) of the multilayered signal guiding structure 100 is shown in the backward direction as a function of the double coupling length 2Lc, which is used, for example, in an isolator.

In FIGS. 10 to 12 it may be seen that for an MO material with, for example, a used gyrotropy level of g≈0.01, for which the ratio reaches a needed value of 2a=0.97 μm, which corresponds to a coupling length of Lc=500 μm, an I.R>30 dB with an I.L<1 dB is achieved. In this case, the power P in the waveguides a, b to LC (in FIG. 10 for a switch or circulator) and to 2LC (in FIGS. 11 and 12 for isolators in forward and backward direction) is shown.

As shown in FIGS. 10 and 11, the power P of the input signal is completely transferred to only one waveguide a after the single coupling length Lc has been covered, while no power remains in the other waveguide b. With Lc, a switch or a circulator can guide the signal in a desired direction by controlling the orientation of the external magnetic field.

In FIG. 11, which shows the power distribution in the forward direction in an isolator, it may be seen that between 0 μm and Lc, the power P is transferred completely from the waveguide b (gray) to the waveguide a (black). After the input signal has covered a distance Lx of more than the single coupling length Lc, the power is partially transferred back into the waveguide b (see the x-axis in the region Lc>Lx>Lc in FIG. 11). At the output port at 2Lc, the power P in the two waveguides a, b corresponds to the output line in the two waveguides a, b at Lx=0. After covering the double coupling length at Lx=2Lc, both waveguides have their original power P.

In FIG. 12, which shows the power distribution in the backward direction in an isolator, it may be seen that the power transfer from waveguide a (black) to waveguide b (gray) takes place between 0 μm and Lc. The input signal, i.e. the power P, is completely transferred to the waveguide b (see FIG. 12, region between 0 μm and Lc at 500 μm).

Whenever an additional structure SG (see FIGS. 19 and 20) is complementarily placed in the waveguide b to scatter or absorb light at Lx=Lc, the backward propagating signal is completely lost, as seen in FIG. 12 between Lc and 2Lc. The additional structure SG can be a cut SWG-s or an absorbing metal or a resonator or the like.

With regard to FIGS. 11 and 12 it can be summarized that the difference in amplitude between the forward and backward propagating signal results in a high performance of the isolator with a high i.R and very low i.L and low back reflection.

At this point it should also be noted that for a low gyrotropy level g, the coupling length Lc, at which maximum power transfer can take place, increases. However, this has no consequences for the I.L power transfer. If, for example, silicon and/or silicon nitride and/or epoxy resin and/or polymer is used in the waveguide layers 10, the loss is only a few dB/cm.

The method 1300 may further comprise attaching an input port 110 to the multilayered signal guiding structure 100 to introduce coupled modes of the electromagnetic signal into the at least two waveguide layers 10, in particular into the waveguides a and b. Further, the method 1300 may comprise attaching an output port 130 to output an output signal comprising coupled modes. In particular, the output port 130 may be configured to recouple decoupled modes in order to define the output signal.

The method 1300 may further comprise splitting the coupled modes of the electromagnetic signal between the at least two waveguide layers 10, in particular between the waveguides a and b, as already described with respect to FIGS. 10 to 12. The method 1300 may further comprise a decoupling of the modes during a course of the coupled modes in the at least two waveguide layers 10, in particular along the x-axis in the direction of extension, so that at one end of the at least two waveguide layers 10, in particular after a length corresponding to the coupling length Lc, decoupled modes are present in one of the at least two waveguide layers 10, and a subsequent recoupling of the decoupled modes at or in the output port to generate an output signal. Finally, the method 1300 may comprise outputting the output signal. The output signal may be forwarded or processed further.

The proposed technical solution has the following advantages over the state of the art:
The proposed design for the switch/circulator and isolator is simple and involves minimal technical intervention for integration into PICs.
Satisfactory switching, circulation and insulation effects can be realized in many ways by using MO materials with any gyrotropy level. The critical factors for achieving these effects are primarily the geometric parameters, in particular the length and width of the signal guiding structure.
This innovative design is very promising in the field of lossless components, as the primary signal propagation takes place predominantly in waveguides, especially dielectric waveguides, thus avoiding undesirable absorption effects.
The applied external magnetic field works with low power consumption, wherein a rare-earth magnet or an electromagnet can saturate the MO material.
In contrast to Faraday rotators, the proposed technical teaching is characterized by its taught compact footprint.
Compared to conventional NRL and NRPS components, the design has a clear advantage, as it does not cause a higher I.L. even with a longer propagation length.
Compared to resonator-based structures, this novel design features superior performance characterized by a wider bandwidth. This improvement results from the gyrotropy that the MO material exhibits over the entire wavelength spectrum.
The design can provide switching/circulation and insulation, in the form of isolators, for TM and TE modes.
The adaptability of the design is also demonstrated by the option of replacing conventional straight waveguides with SWGs or PhC-s. This exchange effectively reduces the needed coupling length to enable seamless power transmission between different waveguides.
Switching effects can be achieved by controlling or changing the orientation of the external magnetic field and/or by controlling the phases of the input signals.
MO materials can be used according to the third configuration, where a different orientation of the external magnetic field can be used to reduce the footprint of the signal guiding structure.

The combination of these properties makes this innovative design attractive for on-chip applications, for example.

The three components described herein—the switch, the circulator and the isolator—are based on the multilayered, in particular five-layered, signal structure as the core, which comprises at least one MO layer (see first to third configuration). The power exchange takes place in the proposed multilayered signal guiding structure 100, and the various propagating signals take different paths and undergo different processes. Although the components look similar to MZI-s, they differ greatly from each other in the modes that run inside. Compared to conventional MZI-s, in which the arms are far apart and the modes are not coupled, in the present case the intermediate layer 20 does not exceed a certain width and the modes remain coupled throughout the signal guiding structure from the input to the output. The signal guiding structure 100 could be further utilized to achieve optimum performance. The specific width of the intermediate layer 20 has to be selected such that the even and odd modes can be decoupled in the waveguide layers 10. The specific width depends on the material and geometry.

It should be emphasized again at this point that the derivation of the theory for the proposed technical teaching has been limited to five layers for the sake of simplicity.

Instead of the five-layered signal structure, n-layers may be used, especially in the z-direction and/or y-direction, for example to increase or decrease the number of output channels in any direction or to exchange power with different waveguides.

Materials with different indices may also be integrated into the signal structure: for example, placed on the sides of the waveguide to increase the mode confinement in the waveguides and/or placed in the center of the signal guide structure to push the light more towards the waveguides. In addition, more than one signal guiding structure may be stacked to obtain coupled modes in the y-direction.

The position of the MO layer(s) can also lead to different design configurations:
a) The MO material may be placed as an intermediate layer 20 between the two waveguides a and b (first configuration according to FIG. 1).
b) The MO material may be placed on the opposite sides of the waveguides, a and b, in the cover layers 30 (second configuration according to FIG. 2).
c) The MO material may be placed as an intermediate layer 20 between the two waveguides a and b and on the opposite sides of the waveguides, a and b, in the cover layers 30 (third configuration according to FIG. 3)
d) The MO material may be partially or fully etched to make room for rib and ridge waveguide formats (not shown in the figures).

Without an external magnetic field applied, the intensities in the signal guiding structure 100 are the same at both ports. In this case, there is no exchange of power. Therefore, the intensity recorded after any propagation length should be the same in both arms.

In the case of an inwardly directed external magnetic field, where the MO material is saturated, an imbalance between the output powers can be observed (see FIGS. 10 to 12). The unequal amplitudes depend on the length of the signal guiding structure 100, the waveguide material of the waveguide layers 10 and the design. In this case, for example, the intensity in the waveguide a should be higher after a coupling length propagation.

In the case of an outwardly directed magnetic field, where the MO material is saturated, an imbalance between the output powers can be observed. The unequal amplitudes depend on the length of the signal guiding structure 100, the waveguide material in the waveguide layers 10 and the design. In this case, for example, the intensity in the waveguide b should be higher after a coupling length propagation.

Optical switches, circulators and isolators are important components in modern optical networks and provide specific requirements for the efficient management and forwarding of optical signals.

Optical switches are designed to selectively control the path of optical signals within a network. They meet the need for dynamic and flexible rerouting of optical signals, enabling flexible network reconfiguration and wavelength switching. Optical switches play an important role in improving network efficiency and reliability by enabling rapid response to changing traffic demands, fault tolerance and wavelength management. Their ability to redirect light signals to different output ports or fibers makes them indispensable for network operators who want to optimize resource utilization and improve the overall performance of optical communication systems. Currently, these switches are widely used in PICs for programmable photonics, neuromorphic computing, etc. To summarize, optical circulators and switches contribute to the robustness and adaptability of modern optical communication systems. Similarly, optical circulators are used to direct signals of different wavelengths to specific targets. This enables the transmission of multiple data streams over a single optical fiber, which increases the data capacity of the communication network.

Such a switch design can also be used to detect the intensity of the applied external magnetic field. This is widely used in the field of magnetometry. Back engineering can be used to derive the properties of the external magnetic field from the output of connections one and two.

Optical isolators find essential applications in various fields due to their ability to control and manage the flow of light in one direction while blocking it in the other. An important application is the use in fiber optic communication systems. In these systems, optical isolators play a crucial role in preventing backscatter and B.R., which can degrade signal quality. By isolating the incoming and outgoing light paths, they help to maintain signal integrity and minimize signal loss, ensuring reliable data transmission over long distances.

In addition, optical isolators are used in laser systems to protect sensitive laser components from damage caused by feedback, which can destabilize the laser output. This application ensures stable and efficient laser operation in various fields, including medical devices, telecommunications and research laboratories.

Although some aspects have been described in connection with a device or method, it is understood that these aspects also constitute a description of a corresponding method or device, so that a block or component of a device or system is also to be understood as a corresponding method step or as a feature of a method step and vice versa. A complete description of the present invention in the form of method steps or in the form of device features is omitted here for reasons of redundancy.

In the preceding detailed description, various features were sometimes grouped together in examples in order to rationalize the disclosure. This type of disclosure is not intended to be interpreted as meaning that the claimed examples have more features than are expressly stated in each claim. Rather, as the following claims disclose, the object may lie in less than all of the features of a single disclosed example. Consequently, the following claims are hereby incorporated into the detailed description, wherein each claim may stand as its own separate example. While each claim may stand as its own separate example, it should be noted that although dependent claims in the claims refer back to a specific combination with one or more other claims, other examples also include a combination of dependent claims with the object of any other dependent claim or a combination of any feature with other dependent or independent claims. Such combinations are included unless it is stated that a specific combination is not intended. It is further intended that a combination of features of a claim with any other independent claim is also encompassed, even if that claim is not directly dependent on the independent claim.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Jalas, D. et al. (2013) ‘What is—and what is not—an optical isolator’, Nature Photonics, 7(8), pp. 579-582.
[2] Murai, T. et al. (2020) ‘Nonvolatile MO-al switches integrated with a magnet stripe array’, Optics Express, 28(21), pp. 31675.
[3] Shoji, Y., Taniguchi, S. and Yajima, S. (2023) ‘Nonvolatile photonic switch with magnetic materials on a silicon photonic platform [invited]’, Optical Materials Express, 13(9), pp. 2489.
[4] Davoyan, A. R. and Engheta, N. (2013) ‘Nanoscale plasmonic circulator’, New Journal of Physics, 15(8), pp. 083054.
[5] Śmigaj, W. et al. (2010) ‘MO-al circulator designed for operation in a uniform external magnetic field’, Optics Letters, 35(4), pp. 568.
[6] Wang, Z. and Fan, S. (2005) ‘Optical circulators in two-dimensional MO-al photonic crystals’, Optics Letters, 30(15), pp. 1989.
[7] Urs, N. O. et al. (2016) ‘Advanced MO-al microscopy: Imaging from picoseconds to centimeters-imaging spin waves and temperature distributions (invited)’, AIP Advances, 6(5).
[8] Van Parys, W. et al. (2006) ‘Transverse magnetic mode nonreciprocal propagation in an amplifying AlGalnAs/InP optical waveguide isolator’, Applied Physics Letters, 88(7).
[9] Shimizu, H. and Nakano, Y. (2006) ‘Fabrication and characterization of an InGaAsp/InP active waveguide optical isolator with 14.7 db/mm TE mode nonreciprocal attenuation’, Journal of Lightwave Technology, 24(1), pp. 38-43.
[10] Fujita, J. et al. (2000) ‘Waveguide optical isolator based on mach-zehnder interferometer’, Applied Physics Letters, 76(16), pp. 2158-2160.
[11] Kono, N. et al. (2007) ‘Nonreciprocal microresonators for the miniaturization of optical waveguide isolators’, Optics Express, 15(12), p. 7737.
[12] Bi, L. et al. (2011) ‘On-chip optical isolation in monolithically integrated non-reciprocal optical resonators’, Nature Photonics, 5(12), pp. 758-762.
[13] Tien, M.-C. et al. (2011) ‘Silicon Ring isolators with bonded nonreciprocal MO garnets’, Optics Express, 19(12), pp. 11740.
[14] Firby, C. J. and Elezzabi, A. Y. (2016) ‘Magnetoplasmonic isolators utilizing the nonreciprocal phase shift’, Optics Letters, 41(3), p. 563.
[15] Abadian, S. et al. (2021) ‘Broad-band Plasmonic Isolator compatible with low-gyrotropy MO-al material’, Optics Express, 29(3), p. 4091.
[16] Ando, K., Okoshi, T. and Koshizuka, N. (1988) ‘Waveguide MO isolator fabricated by laser annealing’, Applied Physics Letters, 53(1), pp. 4-6.
[17] Castera, J.-P. et al. (1989) ‘Single mode integrated magnetooptical isolator’, SPIE Proceedings [Preprint].
[18] Levy, M. et al. (1996) ‘Integrated optical isolators with sputter-deposited thin-film magnets’, IEEE Photonics Technology Letters, 8(7), pp. 903-905.
[19] Sugimoto, N. et al. (1996) ‘A hybrid integrated waveguide isolator on a silica-based planar Lightwave Circuit’, Journal of Lightwave Technology, 14(11), pp. 2537-2546.
[20] Shintaku, T. (1998) ‘Integrated Optical Isolator based on efficient nonreciprocal radiation mode conversion’, Applied Physics Letters, 73(14), pp. 1946-1948.
[21] Fujita, J. et al. (2000) ‘Waveguide optical isolator based on mach-zehnder interferometer’, Applied Physics Letters, 76(16), pp. 2158-2160.
[22] Yokoi, H. et al. (2000) ‘Demonstration of an optical isolator with a semiconductor guiding layer that was obtained by use of a nonreciprocal phase shift’, Applied Optics, 39(33), p. 6158.
[23] Van Parys, W. et al. (2006) ‘Transverse magnetic mode nonreciprocal propagation in an amplifying algainas/inp optical waveguide isolator’, Applied Physics Letters, 88(7).
[24] Shimizu, H. and Nakano, Y. (2006) ‘Fabrication and characterization of an InGaAsp/InP active waveguide optical isolator with 14.7 db/mm TE mode nonreciprocal attenuation’, Journal of Lightwave Technology, 24(1), pp. 38-43.
[25] Kono, N. et al. (2007) ‘Nonreciprocal microresonators for the miniaturization of optical waveguide isolators’, Optics Express, 15(12), p. 7737.
[26] Shoji, Y. and Mizumoto, T. (2014) ‘MO-al non-reciprocal devices in Silicon Photonics’, Science and Technology of Advanced Materials, 15(1), p. 014602.
[27] Montoya, J. et al. (2009) ‘Surface plasmon isolator based on nonreciprocal coupling’, Journal of Applied Physics, 106(2).
[28] Zhu, H. and Jiang, C. (2011) ‘Optical isolation based on nonreciprocal micro-ring resonator’, Journal of Lightwave Technology, 29(11), pp. 1647-1651.
[29] Bi, L. et al. (2011) ‘On-chip optical isolation in monolithically integrated non-reciprocal optical resonators’, Nature Photonics, 5(12), pp. 758-762.
[30] Zhang, Y. et al. (2019) ‘Monolithic integration of broadband optical isolators for polarization-diverse silicon photonics’, Optica, 6(4), p. 473.
[31] Srinivasan, K. et al. (2020) ‘High-gyrotropy seedlayer-free CE:TbIG for monolithic laser-matched SOI optical isolators’, Conference on Lasers and Electro-Optics [Preprint].
[32] Abadian, S. et al. (2021) ‘Broad-band Plasmonic Isolator compatible with low-gyrotropy MO-al material’, Optics Express, 29(3), p. 4091.
[33] Zongfu Yu and Shanhui Fan (2010) ‘Integrated nonmagnetic optical isolators based on photonic transitions*, IEEE Journal of Selected Topics in Quantum Electronics, 16(2), pp. 459-466.
[34] Wang, C., Zhong, X.-L. and Li, Z.-Y. (2012) ‘Linear and passive silicon optical isolator’, Scientific Reports, 2(1).
[35] Ruesink, F. et al. (2016) ‘Nonreciprocity and magnetic-free isolation based on optomechanical interactions’, Nature Communications, 7(1).
[36] Kittlaus, E. A. et al. (2020) ‘Electrically driven acousto-optics and broadband non-reciprocity in Silicon Photonics’, Nature Photonics, 15(1), pp. 43-52.
[37] Tian, H. et al. (2021) ‘Magnetic-free silicon nitride integrated optical isolator’, Nature Photonics, 15(11), pp. 828-836.
[38] Goswami, K. et al. (2022) ‘Design and analysis of all-optical isolator based on linear photonic crystal’, Brazilian Journal of Physics, 52(3).
[39] Yu, M. et al. (2023) ‘Integrated electro-optic isolator on thin-film lithium niobate’, Nature Photonics, 17(8), pp. 666-671.
[40] Zvezdin, A. K., Zvezdin, A. K. and Kotov, V. A. (2020) Modern magnetooptics and magnetooptical materials. Boca Raton: CRC Press Taylor & Francis Group.
[41] Tepper, T. and Ross, C. A. (2003) ‘Pulsed laser deposition and refractive index measurement of fully substituted bismuth iron garnet films’, Journal of Crystal Growth, 255(3-4), pp. 324-331.
[42] Chuang, S. L. (1995) Physics of optoelectronic devices. New York, NY: Wiley.

1. A multilayered signal guiding structure, comprising:
a plurality of layers, wherein the plurality of layers
comprises at least two waveguide layers, which extend along an extension direction and which serve to couple an electromagnetic signal, and at least one intermediate layer that is arranged between the at least two waveguide layers;
at least two cover layers, wherein the at least two waveguide layers are partially or completely arranged between the at least two cover layers, wherein the at least one intermediate layer comprises a magneto-optical material, MO, and/or the at least two cover layers comprise a magneto-optical material, MO.

2. The multilayered signal guiding structure according to claim 1, wherein an external magnetic field can be applied or is applied to the multilayered signal guiding structure, whereby a transverse magnetic mode, TM mode, and/or a transverse electric mode, TE mode, of the electromagnetic signal coupled into the at least two waveguide layers undergoes a change in its electromagnetic field profile aligned along the direction of extension of the at least two waveguide layers.

3. The multilayered signal guiding structure according to claim 1, wherein the at least two waveguide layers and/or at least one intermediate layer and/or the at least two cover layers are dielectric.

4. The multilayered signal guiding structure according to claim 2, wherein the external magnetic field is given by a rare earth magnet or by an electromagnet which is configured to saturate the MO material.

5. The multilayered signal guiding structure according to claim 4, wherein the electromagnet is configured as a metal layer or a semi-metal layer or a semiconductor layer that is positioned directly on the MO material or on the at least one cover layer.

6. The multilayered signal guiding structure according to claim 1, wherein a wave propagation of the electromagnetic signal coupled into the at least two waveguide layers is in each case, in particular individually, described by a propagation constant, wherein the propagation constants of the at least two waveguide layers are different, βₐ≠β_{b}.

7. The multilayered signal guiding structure according to claim 2, wherein at least one TM mode propagates in at least one waveguide layer of the at least two waveguide layers along the extension direction when an external magnetic field is applied, wherein at least one even TM mode is described by a first propagation constant and an odd TM mode is described by a second propagation constant, wherein the at least two waveguide layers are each described by the further propagation constants, wherein at a ratio of the propagation constants of
$$Ratio = \frac{{β}_{a} - {β}_{b}}{{β}_{e} - {β}_{o}} = 0.707107$$
a maximum power transmission takes place, where βₐ is the propagation constant of the fundamental mode of the first waveguide layer of the at least two waveguide layers and β_{b} is the propagation constant of the fundamental mode of the second waveguide layer of the at least two waveguide layers.

8. The multilayered signal guiding structure according to claim 1, wherein each waveguide layer defines a coupling length due to its nature, so that the coupled modes introduced into the waveguide layer are decoupled after covering the coupling length L_{C}.

9. The multilayered signal guiding structure according to claim 6, wherein the coupling length L_{C} is a function of the first and second propagation constants of the even and odd modes and is given by:
$${L}_{c} = \frac{π}{{β}_{e} - {β}_{o}} .$$

10. The multilayered signal guiding structure according to claim 1, wherein each MO material used in the multilayered signal structure comprises a gyrotropy level or different gyrotropy levels.

11. The multilayered signal guiding structure according to claim 1, wherein a length of the at least two waveguide layers and a length of the at least one intermediate layer comprise a configuration with equal length.

12. The multilayered signal guiding structure according to claim 1, wherein a thickness of the at least two waveguide layers is between 0.1 μm and 4 μm.

13. The multilayered signal guiding structure according to claim 1, wherein the at least two waveguide layers extend parallel to each other along the direction of extension.

14. The multilayered signal guiding structure according to claim 1, wherein a thickness of the at least one intermediate layer is between a value greater than 0 μm and 10 μm.

15. The multilayered signal guiding structure according to claim 1, wherein a thickness of one of the cover layers is between a value greater than 0 μm and 50 μm or between 0.0 μm and infinity.

16. The multilayered signal guiding structure according to claim 1, wherein the multilayered signal guiding structure comprises at least one input port for introducing the electromagnetic signal and at least one output port for outputting an output signal, wherein the input port is configured to introduce coupled modes of the electromagnetic signal into the at least two waveguide layers and the at least one output port is configured to recouple the modes decoupled in the at least two waveguide layers along the direction of extension.

17. The multilayered signal guiding structure according to claim 1, wherein the multilayered signal guiding structure is configured by its structure,
to provide an isolation for TM and TE modes of an electromagnetic wave introduced into the at least two waveguide layers and/or
to allow the TM and TE modes in the at least two waveguide layers to propagate in a predetermined direction and to prevent propagation in the direction opposite to the predetermined direction and/or
to circulate the TM and TE modes in the at least two waveguide layers.

18. The multilayered signal guiding structure according to claim 1, wherein the multilayered signal guiding structure is configured as a switch, or as a circulator, or as an isolator.

19. The multilayered signal guiding structure according to claim 1, wherein at least two multilayered signal guiding structures are stacked to acquire coupled modes perpendicular to or in the direction of extension.

20. The multilayered signal guiding structure according to claim 1, wherein the MO material is partially or fully etched to provide space for a rib waveguide format and/or a ridge waveguide format.

21. The multilayered signal guiding structure according to claim 1, wherein a waveguide layer comprises silicon and/or silicon nitride and/or silicon dioxide and/or a polymer and/or sol-gel and/or hybrid plasmonic-dielectric material.

22. The multilayered signal guiding structure according to claim 1, wherein the MO material comprises a garnet or a doped garnet or doped silica or sol-gel or ferromagnetic material.

23. The multilayered signal guiding structure according to claim 1, wherein a cover layer comprises silicon dioxide, SiO₂, and/or air and/or polymethyl methacrylate, PMMA, and/or PVA and/or SU-8.

24. The multilayered signal guiding structure according to claim 1, wherein the multilayered signal guiding structure is arranged between a decoupling structure for splitting an input signal at an input of the multilayered signal guiding structure into signals of equal amplitude, and a coupling structure for recoupling an output signal at an output of the multilayered signal guiding structure.

25. The multilayered signal guiding structure according to claim 21, wherein the decoupling structure and the coupling structure are configured as a multi-mode interference coupler or as a Y-junction or as a tree coupler or as a star coupler or as a directional coupler.

26. The multilayered signal guiding structure according to claim 21, wherein the coupling structure comprises an adiabatic coupler, which is designed to avoid backward reflections.

27. The multilayered signal guiding structure according to claim 1, wherein a waveguide layer is configured as a waveguide extending straight along the direction of extension or as a curved waveguide or as a slotted waveguide or as a SWG waveguide or as a PhC waveguide or as a plasmonic-dielectric hybrid waveguide.

28. A method for operating a multilayered signal guiding structure, in particular according to claim 1, comprising:
providing a multilayered signal structure, comprising:
a plurality of layers, wherein the plurality of layers
comprises at least two waveguide layers which extend along an extension direction and which serve to couple an electromagnetic signal, and at least one intermediate layer which is arranged between the at least two waveguide layers;
at least two cover layers, wherein the at least two waveguide layers are partially arranged between the at least two cover layers, wherein the at least one intermediate layer comprises a magneto-optical material, MO, and/or the at least two cover layers comprise a magneto-optical material, MO; and
applying an external magnetic field to the multilayered signal guiding structure, whereby a transverse-magnetic mode, TM mode, or a transverse-electric mode, TE mode, of an electromagnetic signal introduced into the multilayered signal guiding structure undergoes a change in its electromagnetic field profile aligned along an extension direction of the at least two waveguide layers.

29. The method according to claim 26, wherein the electromagnetic signal is concentrated in only one of the at least two waveguide layers depending on an orientation of the external magnetic field to the multilayered signal guiding structure.

30. The method according to claim 26, comprising:
attaching an input port to the multilayered signal guiding structure to introduce coupled modes of the electromagnetic signal into the at least two waveguide layers, and
attaching an output port for outputting an output signal comprising coupled modes.

31. The method according to claim 28, wherein the method comprises:
distributing the coupled modes of the electromagnetic signal to the at least two waveguide layers;
decoupling the modes during a course of the coupled modes in the at least two waveguide layers, so that at one end of the at least two waveguide layer decoupled modes are present in one of the at least two waveguide layers, then
recoupling the decoupled modes at the output port to the output signal; and
outputting the output signal.
